(19) United States
(12) Patent Application Publication
(10) Pub. No.: US 2007/0047857 A1
(43) Pub. Date: Mar. 1, 2007

(54) Sleeve for hydrodynamic bearing device, hydrodynamic bearing device and spindle motor using the same, and method for manufacturing sleeve

(76) Inventors: Tsutomu Hamada, Osaka (JP); Takafumi Asada, Osaka (JP); Katsuo Ishikawa, Ehime (JP)

Correspondence Address: WENDEROTH, LIND & PONACK L.L.P., 2033 K. STREET, NW, SUITE 800, WASHINGTON, DC, 20006, US

(21) Appl. No.: 11/509,770

(22) Filed: Aug. 25, 2006

(30) Foreign Application Priority Data
Aug. 26, 2005 (JP) 2005-245936
Aug. 31, 2005 (JP) 2005-251177

(51) Int. Cl. F16C 33/02; F16C 32/06

(52) U.S. Cl. 384/100; 384/279

(57) ABSTRACT

A bearing stiffness of a sintered metal sleeve is prevented from lowering. A sleeve includes an inner section formed of metal powder for sintering and a resin for impregnation, and a surface deformation section which covers a surface of the inner section and is formed by shot blast process. Since the surface deformation section is formed by the shot blast process, the number of pores formed between the metal powder for sintering near the surface can be reduced. In this way, a supporting pressure at a bearing portion can be prevented from being released out through the pores, and the bearing stiffness can be prevented from lowering.

### CROSS-REFERENCE TO RELATED APPLICATIONS

This application claims priority to Japanese Patent Application Nos. JP 2005-245936 and JP 2005-251177. The entire disclosures of Japanese Patent Application Nos. JP 2005-245936 and JP 2005-251177 are hereby incorporated herein by reference.

### BACKGROUND OF THE INVENTION

1. Field of the Invention

The present invention relates to a sleeve for a hydrodynamic bearing device, particularly, a sleeve formed of sintered metal, a hydrodynamic bearing device and a spindle motor using the same, and a method for manufacturing the sleeve.

In recent years, recording and reproducting apparatus and the like using discs to be rotated experience an increase in a memory capacity and an increase in a transfer rate for data. Thus, bearings used for such recording and reproducting apparatus are required to have high performance and high reliability to constantly rotate a disc load with a high accuracy. Accordingly, hydrodynamic bearing devices suitable for high-speed rotation are used for such rotary devices. The hydrodynamic bearing devices are suitable for high-speed rotation since each of the hydrodynamic bearing devices has oil which serves as a lubricant interposed between a shaft and a sleeve, and generates a pumping pressure by hydrodynamic grooves during rotation. Thus, the shaft rotates in a non-contact state with respect to the sleeve, and no mechanical friction is generated.

Hereinafter, an example of conventional hydrodynamic bearing devices will be described with reference to FIGS. 32 through 34. FIG. 32 is a cross-sectional view schematically showing a structure of a conventional hydrodynamic bearing device. As shown in FIG. 32, the hydrodynamic bearing device includes a shaft 911, a flange 912, a sleeve 913, a thrust plate 914, oil 915, a rotor 916, and a base 917. The shaft 911 is formed integrally with a flange 912. The shaft 911 is inserted into a bearing hole 913C of the sleeve 913 so as to be rotatable. The flange 912 is accommodated within a recessed portion of the sleeve 913. On at least one of an outer peripheral surface of the shaft 911 and an inner peripheral surface of the sleeve 913, hydrodynamic grooves 913A and 913B are formed. On a surface of the flange 912 which opposes the sleeve 913 and on a surface of the flange 912 which opposes the thrust plate 914, hydrodynamic grooves 912A and 912B are formed. The thrust plate 914 is fixed to the sleeve 913. Bearing gaps near the hydrodynamic grooves 913A, 913B, 912A, and 912B are filled with at least the oil 915. To the rotor 916, a disc 918 is fixed.

The sleeve 913 is fixed to the base 917. To the rotor, a rotor magnet (not shown) is fixed. Furthermore, a motor stator (not shown) is fixed to the base 917 at a position opposing the rotor magnet.

An operation of the conventional fluid bearing type rotary device having the above-described structure will be described. When a rotational force is applied to the rotor magnet (not shown), the rotor 916, the shaft 911, the flange 912, and the disc 918 start to rotate. Due to the rotation, the hydrodynamic grooves 913A, 913B, 912A, and 912B gather the oil 915, and generate pumping pressures between the shaft 911 and the sleeve 913, between the flange 912 and the sleeve 913, and between the flange 912 and the thrust plate 914. In this way, the shaft 914 can rotate in a non-contact state with respect to the sleeve 913 and the thrust plate 914 and data on the disc 918 can be recorded/reproduced by a magnetic head or an optical head (not shown).

In general, a sleeve of a hydrodynamic bearing device is made from metal materials by a cutting process and the like. However, in order to further reduce the manufacturing cost, a sleeve made of sintered metal has been proposed (see, for example, Japanese Laid-Open Publication No. 2003-314536). Sintered metal means a sintered body obtained by molding and sintering metal powder of copper alloy or the like, for example. When a sleeve is made from a metal rod by a cutting process, a large amount of swarf is generated and the material is wasted. If a sleeve is made by sintering, metal powder is molded and sintered. Thus, there is no swarf and the materials are not wasted. Furthermore, for producing hydrodynamic grooves on an inner peripheral surface of a sleeve, a cutting process or an electrolytic machining is necessary in a conventional art. On the other hand, if a sleeve is manufactured by sintering, hydrodynamic grooves can be formed at the same time as the sleeve is being formed by previously machining portions of a mold which correspond to the hydrodynamic grooves.

As described above, the number of steps and a time period required for manufacturing a sintered metal sleeve can be reduced a few times from that for making the same sleeve by a cutting process or the like. Manufacturing sleeves by sintering can significantly reduce the manufacturing cost of the sleeves.

However, although the sintered metal sleeve can reduce the manufacturing cost, it has problems in its properties. Specifically, since sintered metal is an aggregate of metal powder, it is porous and has a large number of pores (small spaces formed between the metal powder) inside. The pores include pores inside the sintered body, which are referred to as “structural pore”, and opened pores on a surface of the sintered body, which are referred to as “surface pore”. In normal sintered metal, surface pores and structural pores communicate with each other. Thus, lubricating oil can pass through the sintered body via the pores. When a sintered metal sleeve is used for a hydrodynamic bearing device, lubricating oil passes through the sleeve and a supporting pressure generated at a radial bearing portion is released toward an outer periphery of the sleeve. As a result, for example, the supporting pressure generated at the radial bearing portion is reduced. A stiffness of the radial bearing portion is decreased by about 30%.

In order to prevent the supporting pressure being released toward the outer periphery of the sleeve as described above, a hydrodynamic bearing device having a member of a cup shape fitted to the outer periphery of the sleeve has been proposed. However, since the number of components forming the hydrodynamic bearing device increases with such a structure, a benefit that the manufacturing cost can be reduced by the sintered metal sleeve becomes small. Therefore, in order to utilize the advantage of the sintered metal sleeve of low cost, sintered metal sleeves which do not reduce the bearing stiffness are desired.

In order to respond such a demand, the present inventors have proposed a technique of impregnating a sintered body bearing with a resin to seal pores, and continue developing the technique.

However, when a pressed-powder sintered body bearing is impregnated with a resin, a resin impregnant tends to remain on a surface of the bearing with a normal step. Thus, resin impregnation tends to have an adverse influence on a precision of dimension. Further, it is substantially impossible to completely fill the pores on the surface and inside the pressed powder sintered body, which is a porous material. Moreover, a remained resin attached on a surface of the pressed powder sintered body, which is a porous material, has to be removed from the surface. Thus, the resin hardly remains on the surface. Under such circumstance, an effect of impregnating a resin cannot be fully utilized.

As shown in FIG. 33, a porous sleeve 913 has holes (pores) inside. Therefore, even oil 915 is first injected into an entire bearing gap to a position indicated by letter U in the figure, oil 915A enters into holes inside the sleeve 913 after it is left for about 500 hours. A level of a liquid surface of the oil 915 is lowered to a position indicated by letter V in the figure. Thus, hydrodynamic grooves 913A rub a surface of the shaft 911 and seizes.

As shown in FIG. 33, oil 915B oozes out on an external surface of the porous sleeve 913. The oil 915B evaporates and the oil in a gas form contaminates the surroundings.

Whether there is a problem of insufficient sealing of the pores of the porous sleeve 913 can be checked as follows. First, a sufficient amount of oil is put into a beaker (not shown). Then, the sleeve 913 is dipped and left therein by itself, or with being assembled with a shaft 911, a flange 912 and a thrust plate 914. After about 500 hours, an increase in the total weight is measured to obtain a weight of the oil soaked into the porous material. As shown in FIG. 34, conventionally, a change of 2 mg or more (weight change) has been recognized after dipping for 500 hours at 80° C. The total amount of oil filled in the bearing arrangement is about 10 milligrams. Thus, such a change largely impairs reliability of the hydrodynamic bearing device.

Further, in general, a gap between the sleeve 913 and the shaft 911 in a hydrodynamic bearing device is set to be about 5 μm. Therefore, problems in accuracy in a surface treatment after a pore sealing process, a difference in temperatures of use circumstances in thermal expansion coefficient difference in use, abrasion powder and the like are inevitable for the hydrodynamic bearing device.

### SUMMARY OF THE INVENTION

An object of the present invention is to prevent a bearing stiffness of a sintered metal sleeve from decreasing.

A sleeve for a hydrodynamic bearing device according to the first invention comprises: an inner section formed of metal powder for sintering and a resin for impregnation; and a surface deformation section which covers a surface of the inner section and is formed of metal powder for sintering. An average density of a portion of the metal powder for sintering of the surface deformation section is larger than an average density of a portion of the metal powder for sintering of the inner section.

In such a sleeve, since the average density of the portion of the metal powder for sintering of the surface deformation section is larger than the average density of the portion of the metal powder for sintering of the inner section, the inner section is covered with a layer with less pores. Thus, a supporting pressure of a bearing portion can be prevented from being released out through the pores, and the bearing stiffness can be prevented from lowering. The average density as used herein is obtained by dividing the weight by volume. For example, the average density of the sleeve is obtained by dividing the weight of the sleeve by the volume calculated from an external shape of the sleeve.

A sleeve for a hydrodynamic bearing device according to the second invention comprises: an inner section formed of metal powder for sintering and a resin for impregnation; and a surface deformation section which covers a surface of the inner section and is formed of metal powder for sintering. A density of the portion of the metal powder for sintering of the surface deformation section becomes gradually larger from a side of the inner section toward a surface.

In such a sleeve, since the density of the portion of the metal powder for sintering of the surface deformation section becomes gradually larger from the side of the inner section toward the surface, the density of the surface of the surface deformation section is the largest. Thus, a supporting pressure of a bearing portion can be prevented from being released out through the pores more securely particularly on the surface of the surface deformation section, and the bearing stiffness can be prevented from lowering.

A sleeve for a hydrodynamic bearing device according to the third invention comprises: an inner section formed of metal powder for sintering and a resin for impregnation; and a surface deformation section which covers a surface of the inner section and is formed by a shot blast process.

In such a sleeve, since the surface deformation section is formed by the shot blast process, the number of the pores formed between the metal powders for sintering near the surface can be reduced. Thus, a supporting pressure of a bearing portion can be prevented from being released out through the pores, and the bearing stiffness can be prevented from lowering.

A sleeve for a hydrodynamic bearing device according to the fourth invention is a sleeve of the first invention wherein an average density of the portion of the metal powder for sintering of the inner section is 6.5 g/cm³ or higher.

In such a sleeve, since the average density of the portion of the metal powder for sintering of the inner section is 6.5 g/cm³ or higher, the average of the surface deformation section is higher than that and there are less pores on the sleeve surface. Thus, a supporting pressure of a bearing portion can be prevented from being released out through the pores more securely, and the bearing stiffness can be prevented from lowering.

A sleeve for a hydrodynamic bearing device according to the fifth invention comprises: an inner section including metal powder for sintering; a steam process layer which covers a surface of the inner section and includes iron oxide; and a plating process layer which covers a surface of the steam process layer.

In such a sleeve, a surface of the inner section is covered by oxide generated by steam process, and pores near the surface have their inner walls sealed by the oxide. Thus, a supporting pressure of a bearing portion can be prevented from being released out through the pores.

A sleeve for a hydrodynamic bearing device according to the sixth invention is the sleeve of the fifth invention in which a thickness of the steam process layer is 2 μm or greater.

A sleeve for a hydrodynamic bearing device according to the seventh invention is a sleeve of the fifth invention wherein an average density of the portion of the metal powder for sintering of the inner section is 6.8 g/cm³ or higher.

In such a sleeve, since the average density of the portion of the metal powder for sintering of the inner section is 6.8 g/cm³ or higher, a supporting pressure of a bearing portion can be prevented from being released out through the pores, and the bearing stiffness can be prevented from lowering.

A sleeve for a hydrodynamic bearing device according to the eighth invention is a sleeve of the fifth invention wherein the iron oxide includes Fe₃O₄.

In such a sleeve, since the steam plating layer includes Fe₃O₄ which has electric conductivity, a plating process can be securely performed, and the strength of the plating process layer can be improved.

A sleeve for a hydrodynamic bearing device according to the ninth invention is a sleeve of the fifth invention further comprising a plating process layer which covers a surface of the steam process layer.

In such a sleeve, the inner section is covered by the steam process layer and the plating process layer, and pores near the surface have their inner walls sealed by the oxide formed by the steam process or plating. Thus, a supporting pressure of a bearing portion can be prevented from being released out through the pores. Such a sleeve is employed for using a sintered material of iron.

A sleeve for a hydrodynamic bearing device according to the tenth invention is a sleeve according to the ninth invention wherein: a thickness of the steam process layer is 2 μm or larger; and a thickness of the plating process layer is 2 μm or larger.

In such a sleeve, since the thickness of the steam process layer and the plating process layer are both 2 μm or larger, a supporting pressure of a bearing portion can be prevented from being released out through the pores more securely.

A sleeve for a hydrodynamic bearing device according to the eleventh invention comprises: metal powder for sintering; and a steam process section with iron oxide being formed between particles of the metal powder for sintering.

A sleeve for a hydrodynamic bearing device according to the twelfth invention is a sleeve for a hydrodynamic bearing device into which a shaft of a hydrodynamic bearing device is inserted, comprising: metal powder for sintering; and a steam process section with iron oxide being formed between particles of the metal powder for sintering. The steam process layer is removed at least from an area which generates a dynamic pressure.

A sleeve for a hydrodynamic bearing device according to the thirteenth invention is a sleeve for a hydrodynamic bearing device into which a shaft of a hydrodynamic bearing device is inserted, comprising:metal powder for sintering; a steam process section with iron oxide being formed between particles of the metal powder for sintering; and a steam process layer including iron oxide which is formed to cover a surface of the steam process section. The steam process layer is removed at least from an area which generates a dynamic pressure.

A hydrodynamic bearing device according to the fourteenth invention is a hydrodynamic bearing device for supporting a rotating member so as to be rotatable with respect to a stationary member, comprising: a sleeve according to the fifth invention which is fixed to one of the stationary member and the rotating member; a shaft which is fixed to the other of the stationary member and the rotating member and is provided on an inner peripheral side of the sleeve so as to be relatively rotatable; and a radial bearing portion including a working fluid filled between the sleeve and the shaft, and at least one hydrodynamic groove formed on either an inner peripheral surface of the sleeve or an outer peripheral surface of the shaft.

A hydrodynamic bearing device according to the fifteenth invention is a hydrodynamic bearing device for supporting a rotating member so as to be rotatable with respect to a stationary member, comprising: a sleeve according to the eleventh invention which is fixed to one of the stationary member and the rotating member; a shaft which is fixed to the other of the stationary member and the rotating member and is provided on an inner peripheral side of the sleeve so as to be relatively rotatable; and a radial bearing portion including a working fluid filled between the sleeve and the shaft, and at least one hydrodynamic groove formed on either an inner peripheral surface of the sleeve or an outer peripheral surface of the shaft.

A hydrodynamic bearing device according to the sixteenth invention is a hydrodynamic bearing device for supporting a rotating member so as to be rotatable with respect to a stationary member, comprising: a sleeve according to the twelfth invention which is fixed to one of the stationary member and the rotating member; a shaft which is fixed to the other of the stationary member and the rotating member and is provided on an inner peripheral side of the sleeve so as to be relatively rotatable; and a radial bearing portion including a working fluid filled between the sleeve and the shaft, and at least one hydrodynamic groove formed on either an inner peripheral surface of the sleeve or an outer peripheral surface of the shaft.

A hydrodynamic bearing device according to the seventeenth invention is a hydrodynamic bearing device for supporting a rotating member so as to be rotatable with respect to a stationary member, comprising: a sleeve according to the thirteenth invention which is fixed to one of the stationary member and the rotating member; a shaft which is fixed to the other of the stationary member and the rotating member and is provided on an inner peripheral side of the sleeve so as to be relatively rotatable; and a radial bearing portion including a working fluid filled between the sleeve and the shaft, and at least one hydrodynamic groove formed on either an inner peripheral surface of the sleeve or an outer peripheral surface of the shaft.

A hydrodynamic bearing device according to the eighteenth invention is a hydrodynamic bearing device for supporting a rotating member so as to be rotatable with respect to a stationary member, comprising: a sleeve according to the fifth invention which is fixed to the stationary member; a shaft which is fixed to the rotating member and is provided on an inner peripheral side of the sleeve so as to be relatively rotatable; a radial bearing portion including a working fluid filled between the sleeve and the shaft, and at least one hydrodynamic groove formed on either an inner peripheral surface of the sleeve or an outer peripheral surface of the shaft; and a cover member of a tubular shape fitted to an outer periphery of the sleeve.

Since such a hydrodynamic bearing device includes a sleeve according to the fifth invention, a sleeve of a hydrodynamic bearing device which has a circulating function can be manufactured by sintering. Thus, the manufacturing cost can be reduced, and the bearing stiffness can be prevented from lowering in such a hydrodynamic bearing device.

A hydrodynamic bearing device according to the nineteenth invention is a hydrodynamic bearing device for supporting a rotating member so as to be rotatable with respect to a stationary member, comprising: a sleeve according to the eleventh invention which is fixed to the stationary member; a shaft which is fixed to the rotating member and is provided on an inner peripheral side of the sleeve so as to be relatively rotatable; a radial bearing portion including a working fluid filled between the sleeve and the shaft, and at least one hydrodynamic groove formed on either an inner peripheral surface of the sleeve or an outer peripheral surface of the shaft; and a cover member of a tubular shape fitted to an outer periphery of the sleeve.

A hydrodynamic bearing device according to the twentieth invention is a hydrodynamic bearing device for supporting a rotating member so as to be rotatable with respect to a stationary member, comprising: a sleeve according to the twelfth invention which is fixed to the stationary member; a shaft which is fixed to the rotating member and is provided on an inner peripheral side of the sleeve so as to be relatively rotatable; a radial bearing portion including a working fluid filled between the sleeve and the shaft, and at least one hydrodynamic groove formed on either an inner peripheral surface of the sleeve or an outer peripheral surface of the shaft; and a cover member of a tubular shape fitted to an outer periphery of the sleeve.

A hydrodynamic bearing device according to the twenty-first invention is a hydrodynamic bearing device for supporting a rotating member so as to be rotatable with respect to a stationary member, comprising: a sleeve according to the thirteenth invention which is fixed to the stationary member; a shaft which is fixed to the rotating member and is provided on an inner peripheral side of the sleeve so as to be relatively rotatable; a radial bearing portion including a working fluid filled between the sleeve and the shaft, and at least one hydrodynamic groove formed on either an inner peripheral surface of the sleeve or an outer peripheral surface of the shaft; and a cover member of a tubular shape fitted to an outer periphery of the sleeve.

A manufacturing method of a sleeve for a hydrodynamic bearing device according to the twenty-second invention, comprises: forming a primary compact from metal powder for sintering; sintering the primary compact; sizing the sintered primary compact with a sizing process to form a secondary compact; impregnating the secondary compact with resin; and shot-blasting the secondary compact.

In such a manufacturing method, since the secondary compact is treated with the resin impregnation process, the resin can enter the pores. Further, the secondary compact treated with the resin impregnation process is treated with the shot blast process. Thus, the pores formed near the surface of the secondary compact and including the resin can be sealed, and a layer with less pores and a high average density of the portion of the metal powder for sintering can be formed on a surface of the primary compact. As a result, a layer with a high average density of the portion of the metal powder for sintering and the pores including the resin can be formed on a surface of the sleeve. In this way, a sleeve which can prevent a supporting pressure of a bearing portion from being released out through the pores can be manufactured by the manufacturing method. The bearing stiffness can be prevented from lowering, and the manufacturing cost can be decreased compared to the case of the conventional sintered metal sleeve.

A manufacturing method of a sleeve for a hydrodynamic bearing device according to the twenty-third invention is a manufacturing method of the twenty-second invention wherein an average density of the portion of the metal powder for sintering of the secondary compact is 6.5 g/cm³ or higher.

In such a manufacturing method, since average density of the portion of the metal powder for sintering of the secondary compact is 6.5 g/cm³ or higher, effects of the shot blast process and the resin impregnation process can be enhanced.

A manufacturing method of a sleeve for a hydrodynamic bearing device according to the twenty-fourth invention comprises: forming a primary compact from metal powder for sintering; sintering the primary compact; sizing the sintered primary compact to form a secondary compact; and contacting the sintered primary compact or secondary compact with a high-temperature steam.

In such a manufacturing method, since the primary compact or the secondary compact contact a high-temperature steam, steam enters pores between particles of metal powder for metal powder for sintering, and oxide is formed on the surface of the compact. Thus, inner walls of the pores are sealed by the oxide. As a result, the supporting pressure at the bearing portion can be prevented from being released out.

A manufacturing method of a sleeve for a hydrodynamic bearing device according to the twenty-fifth invention is a manufacturing method according to the twenty-fourth invention, further comprising: finishing a surface of the primary compact or the secondary compact treated in the steam process.

The surface finishing may be plating process and DLC film coating process and the like, for example.

A manufacturing method of a sleeve for a hydrodynamic bearing device according to the twenty-sixth invention is a manufacturing method according to the twenty-fourth invention, further comprising: removing at least a part of an iron oxide film formed on a surface of the primary compact or the secondary compact at the steam process.

In this way, at least an oxide film on a surface of an inner peripheral surface of the sleeve which opposes an outer peripheral surface of the shaft is removed. Thus, problems such that a film peels off due to a shock or the like and enters a bearing gap, causing the shaft to wear out can be prevented.

A manufacturing method of a sleeve for a hydrodynamic bearing device according to the twenty-seventh invention is a manufacturing method of the twenty-fifth invention wherein the primary compact or the secondary compact is treated with nonelectrolytic nickel plating process or DLC film coating process in the surface finishing.

A manufacturing method of a sleeve for a hydrodynamic bearing device according to the twenty-eighth invention is a manufacturing method of the twenty-fourth invention wherein an average density of a portion of the metal powder for sintering of the secondary compact is 6.8 g/cm³ or higher.

In such a manufacturing method, since average density of the portion of the metal powder for sintering of the secondary compact is 6.8 g/cm³ or higher, effects of the steam process and the surface finishing can be enhanced.

A manufacturing method of a sleeve for a hydrodynamic bearing device according to the twenty-ninth invention is a manufacturing method of the twenty-fourth invention wherein: the primary compact includes a tubular sleeve main body and a tubular projection projecting from the sleeve main body in an axial direction; and a rate of change in a dimension of the tubular projection is larger than a rate of change in a dimension of the sleeve main body in the sizing process.

In such a manufacturing method, since the rate of change in the dimension of the tubular projection is larger than the rate of change in the dimension of the sleeve main body, a density at a step such as joint between the sleeve main body and the projection, for example, can be made high. In this way, by changing partially the rate of change of the dimensions in the sizing process, the density of the portion of the mold which is difficult to put the metal powder for sintering can be made high by the sizing process. The effects of the above-mentioned manufacturing method can be enhanced.

A manufacturing method of a sleeve for a hydrodynamic bearing device according to the thirtieth invention is a manufacturing method of the twenty-fourth invention, comprising: a sleeve; a shaft inserted into a bearing hole of the sleeve so as to be relatively rotatable; and at least one radial bearing having hydrodynamic grooves formed on at least one of an outer peripheral surface of the shaft and an inner peripheral surface of the sleeve. A volume density of a portion of the metal powder for sintering of the secondary compact is 85% or higher.

A manufacturing method of a sleeve for a hydrodynamic bearing device according to the thirty-first invention is a manufacturing method according to the twenty-fourth invention, wherein: the sleeve is brought into contact with a high-temperature steam at an atmospheric temperature within the range of 600 to 700° C. for 15 to 50 minutes in the steam process.

A manufacturing method of a sleeve for a hydrodynamic bearing device according to the thirty-second invention is a manufacturing method according to the twenty-fourth invention, wherein: the sleeve is brought into contact with a high-temperature steam at an atmospheric temperature within the range of 400 to 700° C. for 25 to 80 minutes in the steam process.

A sleeve for a hydrodynamic bearing device according to the thirty-third invention is a sleeve of the fifth invention comprising at least one groove portion which is provided on an outer peripheral side and extends in the axial direction.

A sleeve for a hydrodynamic bearing device according to the thirty-fourth invention is a sleeve of the eleventh invention comprising at least one groove portion which is provided on an outer peripheral side and extends in the axial direction.

A sleeve for a hydrodynamic bearing device according to the thirty-fifth invention is a sleeve of the twelfth invention comprising at least one groove portion which is provided on an outer peripheral side and extends in the axial direction.

A sleeve for a hydrodynamic bearing device according to the thirty-sixth invention is a sleeve of the thirteenth invention comprising at least one groove portion which is provided on an outer peripheral side and extends in the axial direction.

A spindle motor according to thirty-seventh invention, comprises: a base plate as the stationary member; a stator of a circular shape which is fixed to the base plate and to which a stator coil is wound around; a hydrodynamic bearing device according to the fourteenth invention for supporting the rotor so as to be rotatable with respect to the base plate.

Since the spindle motor includes a hydrodynamic bearing device according to the fourteenth invention, the manufacturing cost can be reduced.

A spindle motor according to thirty-eighth invention, comprises: a base plate as the stationary member; a stator of a circular shape which is fixed to the base plate and to which a stator coil is wound around; a hydrodynamic bearing device according to the fifteenth invention for supporting the rotor so as to be rotatable with respect to the base plate.

A spindle motor according to thirty-ninth invention, comprises: a base plate as the stationary member; a stator of a circular shape which is fixed to the base plate and to which a stator coil is wound around; a hydrodynamic bearing device according to the sixteenth invention for supporting the rotor so as to be rotatable with respect to the base plate.

A spindle motor according to fortieth invention, comprises: a base plate as the stationary member; a stator of a circular shape which is fixed to the base plate and to which a stator coil is wound around; a hydrodynamic bearing device according to the seventeenth invention for supporting the rotor so as to be rotatable with respect to the base plate.

A spindle motor according to forty-first invention, comprises: a base plate as the stationary member; a stator of a circular shape which is fixed to the base plate and to which a stator coil is wound around; a hydrodynamic bearing device according to the eighteenth invention for supporting the rotor so as to be rotatable with respect to the base plate.

A spindle motor according to forty-second invention, comprises: a base plate as the stationary member; a stator of a circular shape which is fixed to the base plate and to which a stator coil is wound around; a hydrodynamic bearing device according to the nineteenth invention for supporting the rotor so as to be rotatable with respect to the base plate.

A spindle motor according to forty-third invention, comprises: a base plate as the stationary member; a stator of a circular shape which is fixed to the base plate and to which a stator coil is wound around; a hydrodynamic bearing device according to the twentieth invention for supporting the rotor so as to be rotatable with respect to the base plate.

A spindle motor according to forty-fourth invention, comprises: a base plate as the stationary member; a stator of a circular shape which is fixed to the base plate and to which a stator coil is wound around; a hydrodynamic bearing device according to the twenty-first invention for supporting the rotor so as to be rotatable with respect to the base plate.

A sleeve for a hydrodynamic bearing device according to the present invention can prevent a supporting pressure of a bearing portion from being released out through the pores, and the bearing stiffness from lowering.

Further, a manufacturing method of a sleeve for a hydrodynamic bearing device according to the present invention can manufacture a sleeve which can prevent the bearing stiffness from lowering, and the manufacturing cost for the sleeve can be decreased without deteriorating bearing performance.

In a hydrodynamic bearing device according to the present invention, as described above, a sleeve has the film of magnetite (Fe₃O₄) formed on the porous material of pressed-powder molded sintered metal body with a volume density of 85% or higher (or 6.8 g/cm³ or higher). Further, the magnetite (Fe₃O₄) film is formed by treating the porous material of pressed-powder molded sintered metal body with a water vapor process (steam process) at an atmospheric temperature within the range of 400 to 700° C. Thus, not only that the magnetite (Fe₃O₄) film is formed even inside the sintered body material through pores, the holes of the porous material are sealed sufficiently, and the mechanical strength is increased, but also the surface roughness of the sintered body bearing can be improved. Particularly, the arrangement is useful as the hydrodynamic bearing device, and is suitable for miniaturizing the spindle motor.

Moreover, in the hydrodynamic bearing device according to the present invention, the surface of the sleeve is further treated with a nonelectrolytic nickel plating of a component including nickel or DLC film coating. In this way, abrasion of the surface, and removal of the magnetite (Fe₃O₄) film can be prevented. Thus, a bearing member with higher reliability can be obtained. Further, if the sintered body is impregnated with a resin or water glass, soaking of the oil into the holes can be prevented even when there is a pinhole in the oxide film, the plating, or the like.

### BRIEF DESCRIPTION OF THE DRAWINGS

Referring now to the attached drawings which form a part of this original disclosure:

FIG. 1 is a schematic diagram of a vertical cross-section of a spindle motor 1 which includes a hydrodynamic bearing device employing a sleeve according to Embodiment 1 of the present invention.

FIG. 2 is a schematic diagram of a vertical cross-section of the hydrodynamic bearing device 4.

FIG. 3 is a diagram showing a relationship between an average density of sintered metal and an amount of soaked lubricating oil.

FIG. 4 is a diagram showing a relationship between the average density of sintered metal and the amount of the soaked lubricating oil when a shot blast process is performed.

FIG. 5 is a diagram showing a relationship between the average density of sintered metal and the amount of the soaked lubricating oil when a resin impregnation process is performed.

FIG. 6 is a diagram showing a relationship between the average density of sintered metal and the amount of the soaked lubricating oil when the both the shot blast process and resin impregnation process are used.

FIG. 7 is a schematic diagram of a vertical cross-section of a sleeve 42 (left half).

FIG. 8 is a flow diagram of a method for manufacturing a sleeve according to Embodiment 1 of the present invention (including Modification 1).

FIG. 9 is a flow diagram of a method for manufacturing a sleeve according to Modification 2 of Embodiment 1 of the present invention.

FIG. 10 is a diagram showing a relationship between the average density and the amount of the soaked lubricating oil when the steam process is performed.

FIG. 11 is a diagram showing a relationship between the average density of sintered metal and the amount of the soaked lubricating oil when the plating process is performed.

FIG. 12 is a diagram showing a relationship between the average density and the amount of the soaked lubricating oil when both the steam process and the plating process are performed.

FIG. 13 is a schematic diagram showing a vertical cross-section of a sleeve 142 according to Embodiment 2 of the present invention (left half).

FIG. 14 is a flow diagram of a method for manufacturing a sleeve according to Embodiment 2 of the present invention.

FIGS. 15A and 15B show a schematic view of the sizing process of the manufacturing method according to Embodiment 3 of the present invention.

FIG. 16 is a schematic view of a hydrodynamic bearing device 204 according to Embodiment 4 of the present invention.

FIG. 17 is a cross sectional view of a hydrodynamic bearing device according to Embodiment 5 of the present invention.

FIG. 18 is a diagram illustrating a sleeve in the hydrodynamic bearing device.

FIG. 19 is a diagram illustrating a rotor in the hydrodynamic bearing device.

FIG. 20 is an enlarged view of a cross-section of the sleeve in the hydrodynamic bearing device.

FIG. 21 is a diagram illustrating influence of volume density in the hydrodynamic bearing device.

FIG. 22 is a diagram illustrating a change in a weight of the sleeve in the hydrodynamic bearing device.

FIG. 23 is a diagram illustrating a steam process time in the hydrodynamic bearing device.

FIG. 24 is a diagram illustrating a steam process time in the hydrodynamic bearing device.

FIG. 25 is a schematic diagram showing a vertical cross-section of a sleeve 442 according to Embodiment 7 of the present invention (left half).

FIG. 26 is a flow diagram of a method for manufacturing a sleeve according to Embodiment 7 of the present invention.

FIG. 27 shows a variation of Embodiment 7 of the present invention.

FIG. 28 is a schematic diagram showing a vertical cross-section of a sleeve 542 according to Embodiment 8 of the present invention (left half).

FIG. 29 is a flow diagram of a method for manufacturing a sleeve according to Embodiment 8 of the present invention.

FIG. 30 is a schematic diagram showing a vertical cross-section of a sleeve 642 according to Embodiment 9 of the present invention (left half).

FIG. 31 is a flow diagram of a method for manufacturing a sleeve according to Embodiment 9 of the present invention.

FIG. 32 is a cross sectional view of a conventional hydrodynamic bearing device.

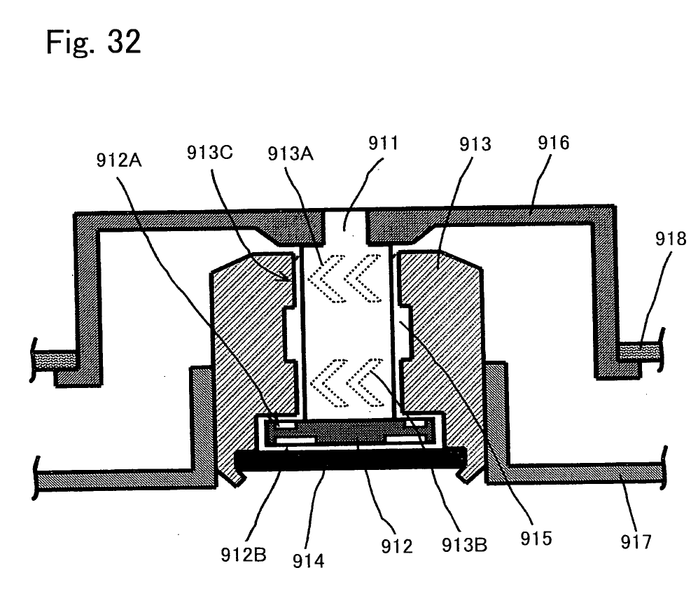

FIG. 33 is a diagram illustrating a sleeve in the conventional hydrodynamic bearing device.

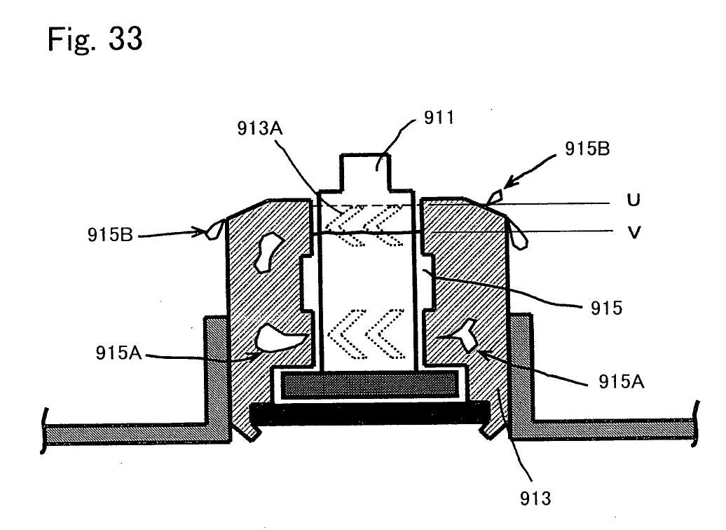

FIG. 34 is a diagram illustrating a change in a weight of the sleeve in the conventional hydrodynamic bearing device.

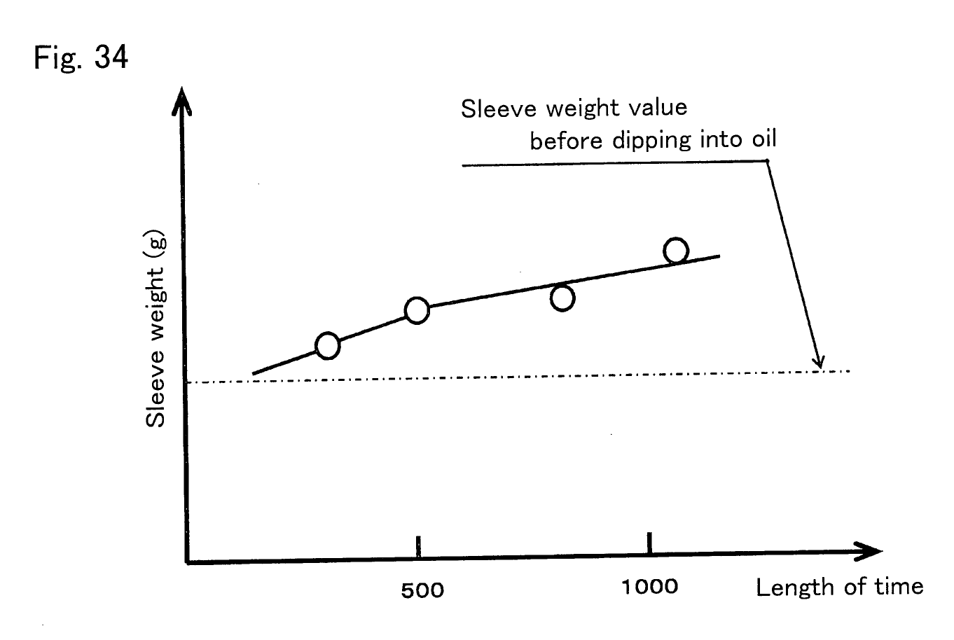

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

First Embodiment

Hereinafter, embodiments of the present invention will be described with reference to the drawings.

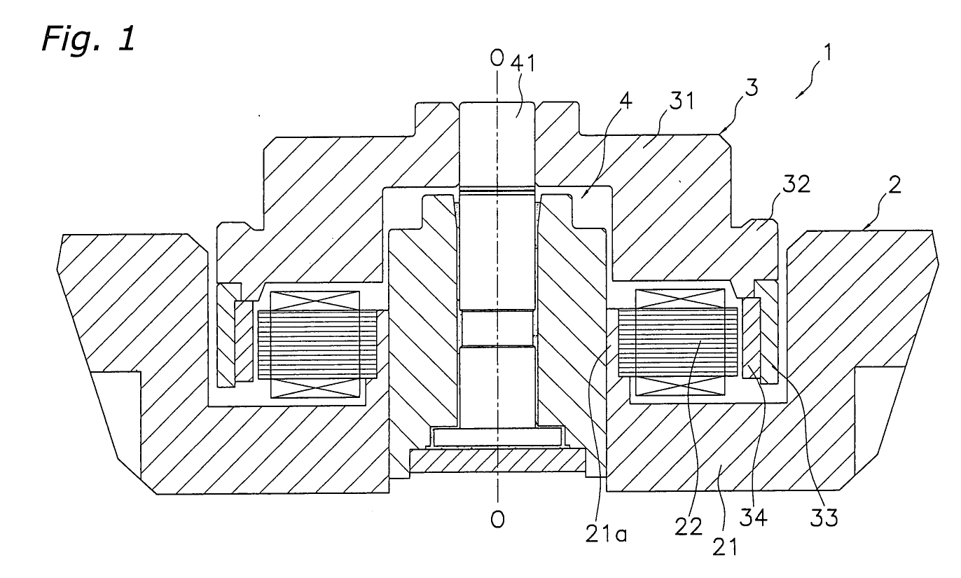

FIG. 1 is a schematic diagram of a vertical cross-section of a spindle motor 1 which includes a hydrodynamic bearing device employing a sleeve according to Embodiment 1 of the present invention. Line O-O shown in FIG. 1 is a rotational shaft of the spindle motor 1. In the description of the present embodiment, the upper side and the lower side of the figure are respectively referred to as “upper side in the axial direction” and “lower side in the axial direction”. However, these expressions are not intended to limit how the spindle motor 1 is actually attached.

The spindle motor 1 mainly includes a base plate 2 (stationary member), a rotor 3 (rotating member), and a hydrodynamic bearing device 4. Hereinafter, details of the components will be described.

The base plate 2 forms a stationary portion of the spindle motor 1 and is fixed to or forms, for example, a housing (not shown) of a recording and reproducing apparatus. The base plate 2 includes a bracket portion 21, and a stator 22 is mounted. The bracket portion 21 is a ring member which forms a main part of the base plate 2. The bracket portion 21 includes a tubular portion 21a extending upward in the axial direction on an inner peripheral side. The stator 22 is a member forming a magnetic circuit, and is fixed on an outer periphery of the tubular portion 21a. To an inner periphery of the tubular portion 21a, the hydrodynamic bearing device 4, which will be described below, is fixed.

The rotor 3 is a portion which is driven to rotate by a rotational force generated at the magnetic circuit. The rotor 3 includes a rotor hub 31, a disc placement portion 32, a back yoke 33, and a rotor magnet 34. The rotor hub 31 is a portion having a disc shape which forms a main part of the rotor 3, and is jointed to the shaft 41 which will be described below. The disc placement portion 32 is a portion for placing a recording disc (not shown), and is located on an outer peripheral side of the rotor hub 31 in a lower part in the axial direction. In the present embodiment, the rotor hub 31 and the disc placement portion 32 are integrally formed.

The back yoke 33 is a tubular member which is fixed to a lower part of the rotor hub 31 in the axial direction and on an inner peripheral side of the disc placement portion 32. The rotor magnet 34 is fixed to an inner periphery of the back yoke 33, and is located so as to oppose the stator 22 in a radial direction. The rotor magnet 34 and the stator 22 together form the magnetic circuit for driving the rotation of the rotor. Specifically, when an electric current flows through a coil of the stator 22, a rotational force is generated at the rotor magnet 34 and the rotor 3 is driven to rotate. The rotor 3 is supported by the hydrodynamic bearing device 4 so as to be rotatable with respect to the base plate 2.

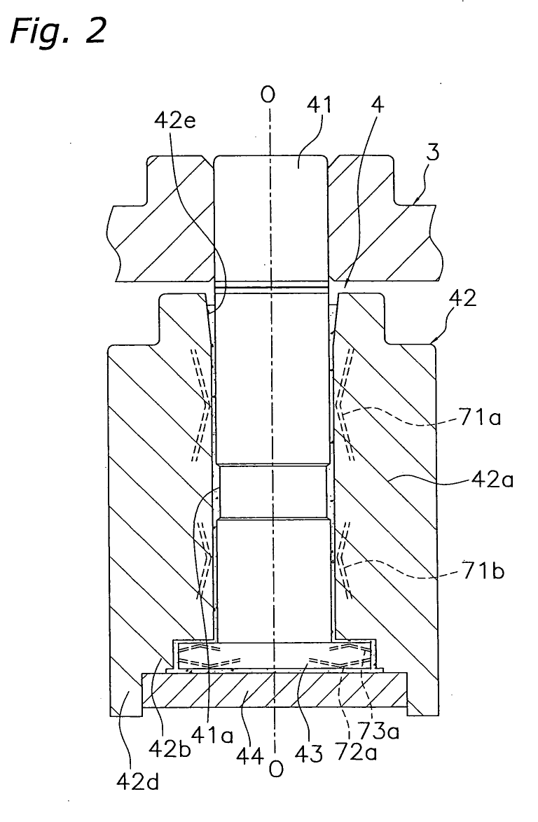

FIG. 2 is a schematic diagram of a vertical cross-section of the hydrodynamic bearing device 4. The hydrodynamic bearing device 4 is for supporting the rotor 3 so as to be rotatable with respect to the base plate 2. The hydrodynamic bearing device 4 includes a sleeve 42, a shaft 41, a thrust plate 44, and a thrust flange 43.

The sleeve 42 is a member of the stationary part of the hydrodynamic bearing device 4, and is a sintered metal member of a tubular shape which is fitted into an inner periphery of the tubular portion 21a of the base plate 2. The sleeve 42 includes a sleeve main body 42a, and at least one (in this embodiment, a plurality of) first hydrodynamic grooves 71a and 71b, a tubular projection 42b, a fixing portion 42d and a sealing portion 42e. The sleeve main body 42a is a tubular portion which forms a main part of the sleeve 42. The first hydrodynamic grooves 71a and 71b are grooves formed on an inner peripheral surface of the sleeve main body 42a and are located with an equal interval therebetween in a circumferential direction. The first hydrodynamic grooves 71a and 71b have, for example, a herringbone pattern. The tubular projection 42b is a circular portion protruding from an end of the sleeve main body 42a in the axial direction. The fixing portion 42d is a circular portion which is further protruding from an end of the tubular projection 42b in the axial direction. The fixing portion 42d is fixed to, for example an outer periphery of the thrust plate 44, which will be described further below, by adhesion or caulking. The sealing portion 42e is a capillary sealing portion which is formed on an inner peripheral side of the sleeve main body 42a in an upper end portion in the axial direction.

The shaft 41 is a member of the rotating part of the hydrodynamic bearing device 4. The shaft 41 is a pillar member located on an inner peripheral side of the sleeve 42. In a conical bearing, the shaft 41 is a member having a conical shape. The shaft 41 has a recessed portion 41a. The recessed portion 41a is a recessed portion having a circular shape formed on an outer peripheral surface of the shaft 41. The recessed portion 41a is located at a position between the above-mentioned first hydrodynamic grooves 71a and 71b.

The thrust flange 43 is a member of the rotating part of the hydrodynamic bearing device 4. The thrust flange 43 is located on an inner peripheral side of the tubular projection 42b. Specifically, the thrust flange 43 is located in a space defined by the sleeve 42 and the thrust plate 44 with a minute space therefrom. The thrust flange 43 has second hydrodynamic grooves 72a on a surface opposing the thrust plate 44 in the axial direction. The thrust flange 43 also has third hydrodynamic grooves 73a on a surface opposing the sleeve main body 42a in the axial direction. Alternatively, the second hydrodynamic grooves 72a may be formed on the thrust plate 44 and the third hydrodynamic grooves 73a may be formed on an end of the sleeve 42.

As described above, in the hydrodynamic bearing device 4, a radial bearing portion 71 for supporting the rotor 3 in the radial direction is formed of the sleeve 42 having the first hydrodynamic grooves 71a and 71b, the shaft 41, and the lubricating oil 46 as a working fluid interposed therebetween. The working fluid may be highly fluidic grease or ionic liquids beside the lubricating oil. Further, a main thrust bearing portion 72 for supporting the rotor 3 in the axial direction is formed of the thrust flange 43 having the second hydrodynamic grooves 72a, the thrust plate 44, and the lubricating oil 46 interposed therebetween. Also, a sub thrust bearing portion 73 is formed of the thrust flange 43 having the third hydrodynamic grooves 73a, the sleeve 42, and the lubricating oil 46 interposed therebeteween. When the members rotate with respect to each other, supporting forces in the radial direction and the axial direction of the shaft 41 are generated at the bearings. Thus, the sleeve 42 is a significantly important member in the hydrodynamic bearing device 4.

As mentioned above, the sleeve 42 according to the present invention is made of sintered metal. The characteristics of sintered metal will be described below in more details.

Sintered metal include a large number of pores (small spaces formed between metal powder) inside. The pores can be divided into two types: pores inside the sintered body which are referred to as “structural pores”; and pores opening on a surface of the sintered body which are referred to as “surface pores”. In conventional types of sintered metals, surface pores and structural pores communicate with each other. Thus, the lubricating oil can pass through the sintered body via the pores. When the sleeve of the hydrodynamic bearing device is made of sintered metal, the lubricating oil soaks into the sleeve. The lubricating oil passes through the sleeve via the pores and oozes out from an outer periphery of the sleeve. As a result, a supporting pressure generated at the radial bearing portion decreases, for example, and a stiffness of the radial bearing portion is reduced by about 30%.

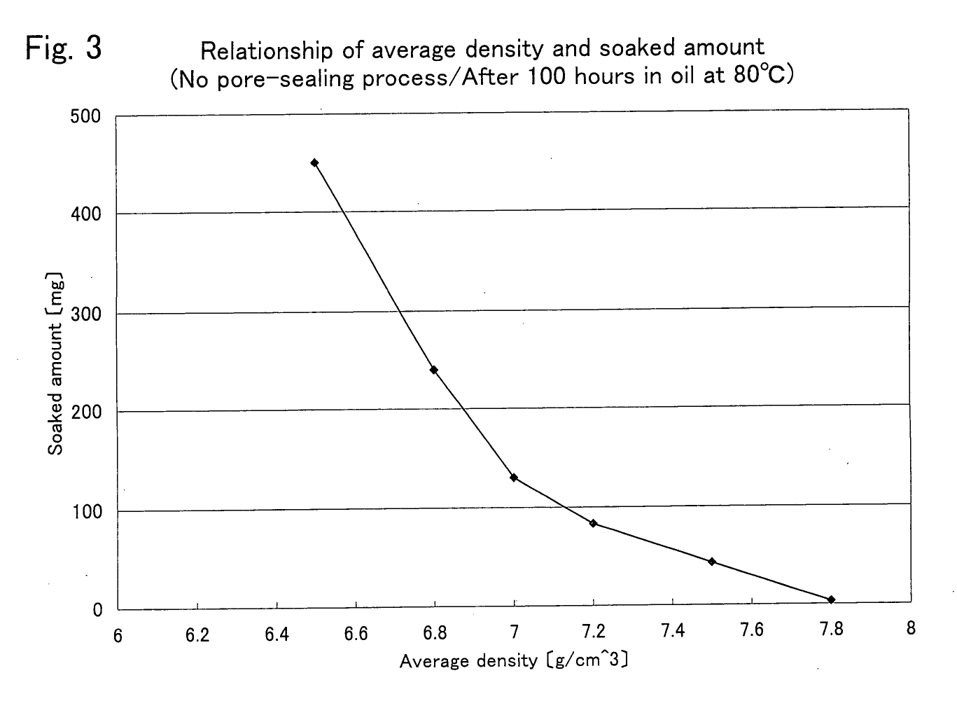

In general, an amount of the lubricating oil soaks into the sintered metal has a relationship with an average density of the sintered metal. The average density as used herein is obtained by dividing the weight of the sintered metal by the volume calculated from its external shape. For example, the density is obtained based on the weight of the sintered body and the volume calculated based on Archimedes method with open pores on the surface of the sintered body being sealed with wax or the like. FIG. 3 shows results of experimentation in which the sintered metal is left in the lubricating oil at 80° C. for about 100 hours. A shown in FIG. 3, when the average density of the metal powder of the sintered metal is small, the amount of the soaked lubricating oil increases since there are a large number of pores. In contrast, when the average density of the metal powder of the sintered metal is large, the amount of the soaked lubricating oil since there are small numbers of pores.

Although the amount of the lubricating oil which soaks can be reduced by increasing the average density, it is not realistic to reduce the amount to a level which allows a sintered metal sleeve to be used for a hydrodynamic bearing device only by adjusting the average density. Thus, treating the sintered metal with a pore-sealing process for sealing the pores is taken into consideration in order to further reduce the amount of the lubricating oil which soaks.

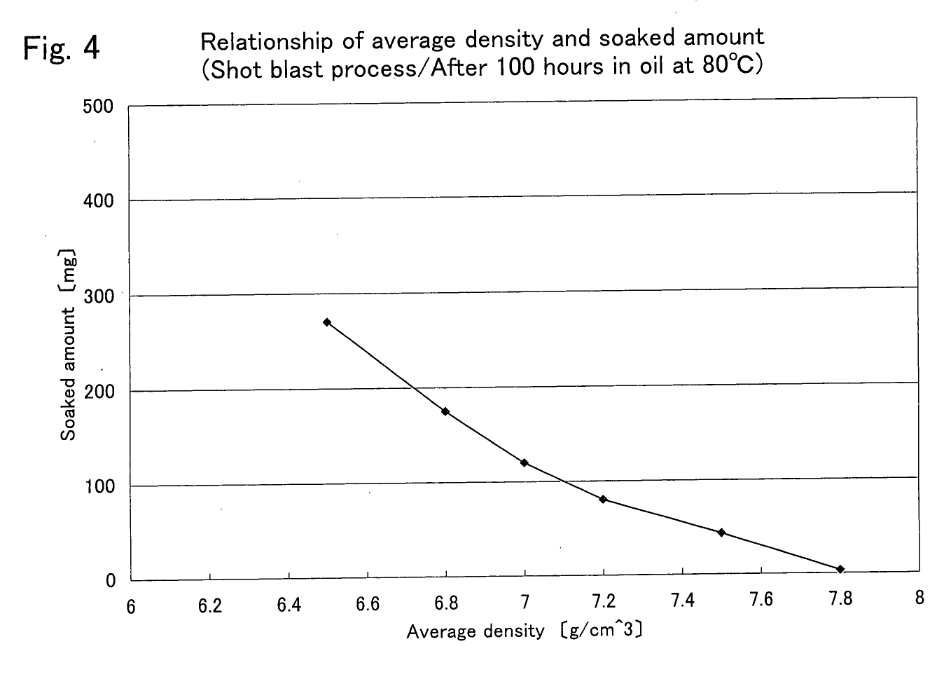

For example, pores may be sealed by treating the sintered metal with a shot blast process to have steel balls strike against the pores near the surface. FIG. 4 shows a relationship between the average density and the amount of the soaked lubricating oil when the shot blast process is performed. From comparison between FIGS. 3 and 4, it is shown that the amount of the soaked lubricating oil is smaller when the sintered metal is treated with a shot blast process than when the shot blast process is not performed. For example, when the average density is 7.0 g/cm³ or higher, there is no significant difference in the amounts of the soaked lubricating oil due to whether the shot blast process is performed or not. On the other hand, when the average density is 6.8 g/cm³ or smaller, the amount of the soaked lubricating oil becomes small, and it is shown that there is an effect in the shot blast process. However, even with the shot blast process, the amount of the soaked lubricating oil through the sintered metal cannot be reduced to a level which allows the sintered metal sleeve to be used for a hydrodynamic bearing device.

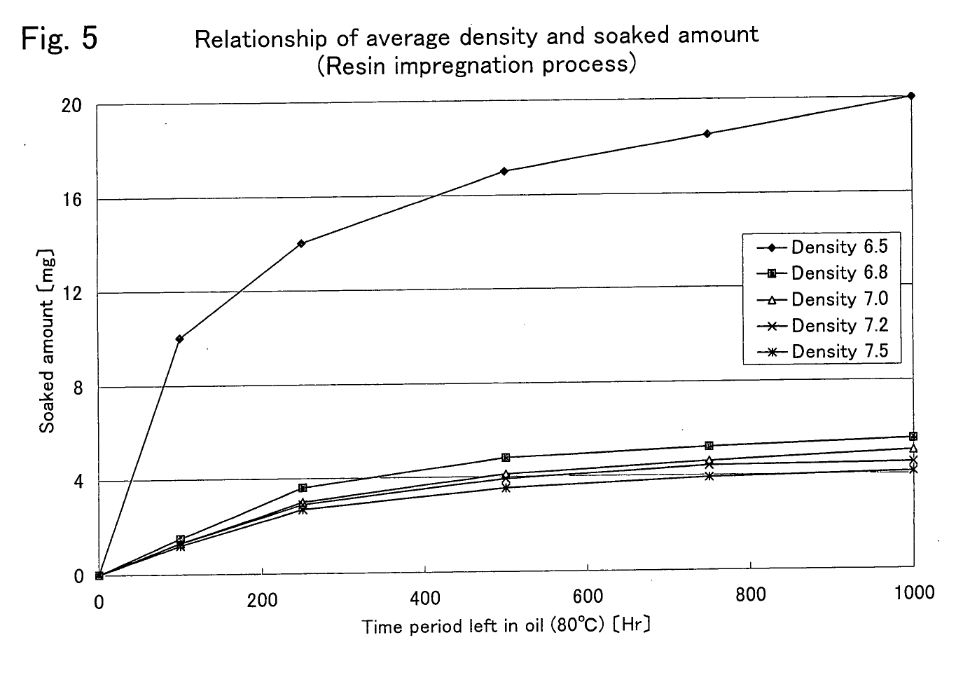

Meanwhile the sintered body may be treated with a process for impregnating a resin so that the pores are previously soaked with the resin. The resin to be impregnated may be, for example, acryl resins, epoxy resins, and the like. FIG. 5 shows a relationship between the average density and the amount of the soaked lubricating oil when a resin impregnation process is performed. As shown in FIG. 5, the amount of the soaked lubricating oil is smaller when the sintered metal is impregnated with a resin than when the resin impregnation process is not performed (this is clear from absolute values on vertical axis which indicates the amount of the soaked lubricating oil after 100 hours). Specifically, when the density is below 6.5 g/cm³, the proportion of the pores in the sintered metal is so large. Thus, the pores cannot be completely filled with the resin, and the amount of the soaked lubricating oil cannot be reduced. However, when the density is 6.8 g/cm³ or higher, the amount of the soaked lubricating oil can be significantly reduced. Yet, although the resin impregnation process has more effect than the shot blast process, the amount of the lubricating oil soaked into the sintered metal cannot be reduced to a level which allows the sintered metal sleeve to be used for a hydrodynamic bearing device.

Now, a specific criterion of the amount of the lubricating oil which soaks into the sintered body will be described. For the sleeve 42 of the hydrodynamic bearing device 4 shown in FIG. 1, the amount which can prevent a decrease in the bearing stiffness is about 20 mg in 1000 hours. However, when 20 mg of the lubricating oil actually soaked into the sleeve, the liquid surface of the lubricating oil lowers. As a result, the lubricating oil is not left in the radial bearing portion, and the hydrodynamic bearing device may seize. Therefore, in view of the seizing of the hydrodynamic bearing device, the amount of the lubricating oil which soaks into the sintered metal which allows the sintered metal sleeve to be used for a hydrodynamic bearing device is about 3.0 mg in 1000 hours. It can be seen from FIG. 5 that even when the average density becomes large and the resin impregnation process is performed, the amount of the lubricating oil soaked into the sintered metal cannot be reduced to a level which allows the sintered metal sleeve to be used for a hydrodynamic bearing device. The value of the criterion may vary depending upon the size of the sleeve and the hydrodynamic bearing device, and is not limited to such a numerical value.

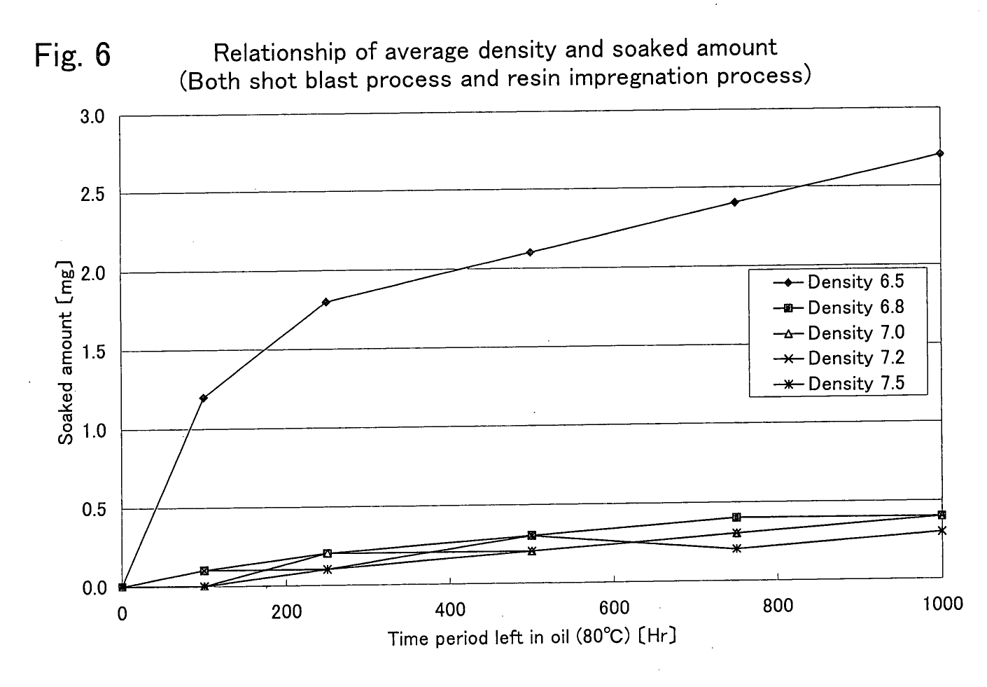

In a manufacturing method according to the present invention, the shot blast process and the resin impregnation process are used together to achieve more effective pore-sealing process than when they are separately used. FIG. 6 shows a relationship between the average density and the amount of the soaked lubricating oil when the sintered metal is treated with both the shot blast process and resin impregnation process. As shown in FIG. 6, when the sintered metal is treated with the shot blast process and the resin impregnation process, the amount of the soaked lubricating oil can be significantly reduced than when they are separately used (FIGS. 4 and 5). When both of the processes are performed, if the density is 6.5 g/cm³ or higher (more preferably, 6.8 g/cm³ or higher), the amount of the soaked lubricating oil can be significantly reduced to a level which allows the sintered metal to be used for a sleeve. From comparison between FIGS. 5 and 6, given the density of 6.5 g/cm³ or higher, the amount of the soaked lubricating oil when the both processes are used is reduced to about one eighth of the amount when only the resin impregnation process is performed. In other words, by treating the sintered metal with both the shot blast process and the resin impregnation process, the amount of the lubricating oil which soaks can be significantly reduced to a level which allows the sintered metal sleeve to be used for a hydrodynamic bearing device.

As described above, the sleeve 42 according to the present invention is treated with the shot blast process and the resin impregnation process in order to reduce the amount of the lubricating oil which soaks into the sintered metal. In the above description, the size of a bearing is about an outer diameter φ 12, an inner diameter φ 4, and length L15, and formed of sintered metal of iron. However, one advantage of the present invention is that iron material is not necessary in some cases, for example, when a stem process which will be described later is used. Similar effects can be obtained with different sizes and different materials for sintered metal (for example, coppers). Hereinafter, sleeve 42 according to the present invention and the manufacturing method thereof will be described.

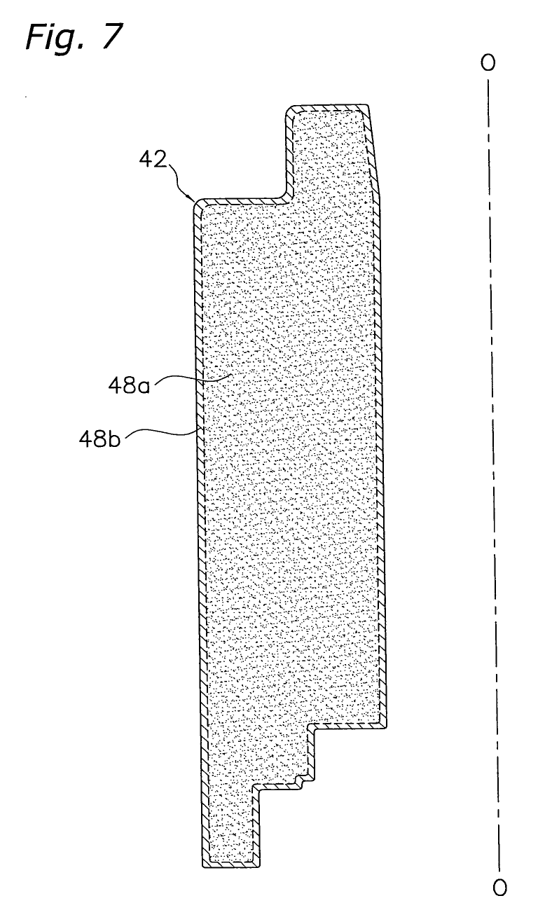

FIG. 7 shows a schematic view of a vertical cross-section of the sleeve 42 (left half). The sleeve 42 is mainly formed of an inner section 48a and a surface deformation section 48b. The inner section 48a is a tubular portion formed of metal powder for sintering and a resin for impregnation. The average density of the portion of the metal powder for sintering of the inner section 48a is 6.5 g/cm³ or higher (more preferably, 6.8 g/cm³ or higher). The surface deformation section 48b covers a surface of the inner section 48a. The surface deformation section 48b is formed of metal powder for sintering and the resin for impregnation. The surface deformation section 48b is a layer formed by a shot blast process, as will be described below. In other words, it is a section which has a shape deformed by the shot blast process. The metal powder for sintering may be a material including at least one of iron, iron alloys, copper, and copper alloys.

In the sleeve 42, the surface deformation section 48b is formed by the shot blast process. Thus, at least a part of the pores of the surface deformation section 48b are sealed. The average density of the portion of the metal powder for sintering of the surface deformation section 48b is higher than the average density of the portion of the metal powder for sintering of the inner section 48a. The inner section 48a is covered by the surface deformation section 48b having less pores. Since the effect of the shot blast process is higher in a surface portion, the density of the portion of the metal powder of the surface deformation section 48b becomes gradually higher from an inner section 48a side toward the surface portion. The density of the surface of the surface deformation section is the highest. FIG. 7 clearly shows a boundary between the inner section 48a and the surface deformation section 48b. However, actually, the density gradually changes in the boundary between the inner section 48a and the surface deformation section 48b. Additionally, since the surface deformation section 48b is formed of the metal powder for sintering and the resin for impregnation, the resin enters into the pores inside the surface deformation section 48b and the inner section 48a. In other words, the sleeve 42 has a structure with less pores on the surface, and a resin are in the pores. In this way, the supporting pressure of the radial bearing portion 71 can be prevented from being released out through the pores, and the bearing stiffness can be prevented from decreasing.

Further, in the sleeve 42, the average density of the portion of the metal powder for sintering of the inner section 48a is 6.5 g/cm³ or higher. The surface deformation section 48b has a density higher than that and has less pores around the surface of the sleeve 42. Therefore, the supporting pressure of the radial bearing portion 71 can be further prevented from being released out through the pores, and the bearing stiffness can be further prevented from decreasing.

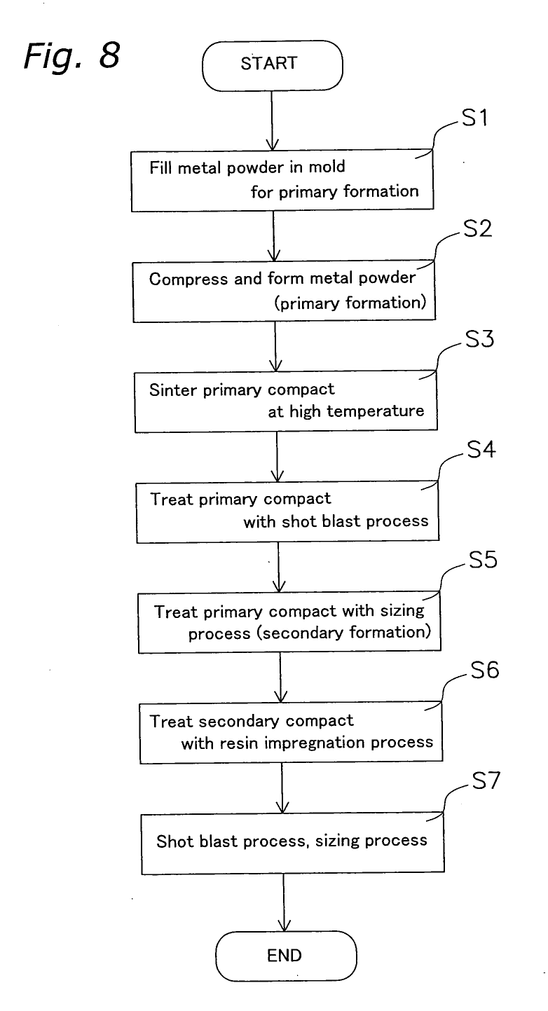

Next, a method for manufacturing the sleeve 42 will be described. FIG. 8 shows a flow diagram of a method for manufacturing a sleeve according to Embodiment 1 of the present invention. As shown in FIG. 8, the manufacturing method includes filling step S1, forming step S2, sintering step S3, shot blast process step S4, sizing process step S5, and resin impregnation process step S6.

In the filling step S1, metal powder including for example, iron, copper or the like is filled in a mold for primary formation. In the forming step S2, the metal powder material filled in the filling step S1 is compressed by using an upper mold and a lower mold for primary formation, and a primary compact is formed. Then, the primary compact is sintered at a high temperature in the sintering step S3.

Next, in the shot blast process step S4, the sintered primary compact is treated with the shot blast process. For performing the shot blast process, steel balls strike against the surface of the primary compact. As a result, pores formed near the surface of the primary compact are sealed, and a layer with no pore or with less pores compared to the inside (the inner section) is formed on a surface of the primary compact. In other words, the surface deformation section having less pores compared to the inside with the higher average density of the portion of the metal powder for sintering is formed on the primary compact by the shot blast process. Conditions for the shot blast process may be as follows. The average particle size of the steel balls is 0.3 mm. The amount of blasting the steel balls is 60 kg/min. The rate of blasting the steel balls is 50 m/s. This set of conditions provides a better result in reducing the amount of the lubricating oil which soaks compared to other conditions.

In the sizing process step S5, the dimension of the primary compact is adjusted. Specifically, in the sizing process step S5, the primary compact treated with the shot blast process is set in a metal mold for secondary formation, which is formed of an inner mold and an outer mold in which the primary compact is placed at a predetermined position, and an upper mold and a lower mold which can be moved up and down freely. The primary compact is compressed by these molds. As a result, the dimension accuracy of the inner and outer peripheral surfaces and both end surfaces of the primary compact is improved, and the secondary compact is formed. By performing the sizing process, the dimension of the primary compact is adjusted, and also, the average density of the metal powder portion of the primary compact can be further increased. For example, the process can increase the average density of the portion of the metal powder of the secondary compact to 6.5 g/cm³ or higher.

After the secondary compact is formed in the sizing process step S5, the secondary body is treated with the resin impregnation process in the resin impregnation process step S6, and the secondary compact is now the sleeve 42. The resin for impregnation may be, for example, acrylic resins, epoxy resins, and the like. By performing the resin impregnation process, the resin enters into the pores formed on the surface of and inside the secondary compact. As a result, the pores formed on the surface of and inside the secondary compact can be sealed. More specifically, the surface deformation section 48b having the density higher than that of the inside and the pores sealed with the resin can be formed on a surface of the sleeve 42. Further, as described above, when the average density of the sintered metal is at a certain level or higher, the lubricating oil can be prevented from passing through the sintered body by performing resin impregnation. Therefore, it is ensured that the sleeve 42 which is manufactured by the above process can prevent the lubricating oil from passing inside through the pores with the surface deformation section 48b formed on the surface. In this way, the manufacturing method can prevent the supporting pressure of the radial bearing portion 71 from being released out through the pores, and the bearing stiffness from decreasing. Also, the manufacturing cost can be reduced.

The above manufacturing method can provide the sintered metal sleeve 42 which can prevent the bearing stiffness from decreasing. Thus, there is no need to provide a covering member for preventing the supporting pressure from being released to the outer periphery of the sleeve 42, and it is ensured that the manufacturing cost can be reduced.

As Modification 1 of Embodiment 1, a manufacturing method which also includes finishing process step S7 after the above mentioned steps may be considered. More specifically, as shown in FIG. 8, in the finishing process step S7, the secondary compact treated with the resin impregnation process is treated with at least one of the shot blast process and the sizing process. In the finishing process step S7, both the shot blast process and the sizing process may be performed. In this modification, since at least one of the shot blast process and the sizing process is performed after the resin impregnation process, the surface roughness of the sleeve 42 after the resin impregnation process can be improved.

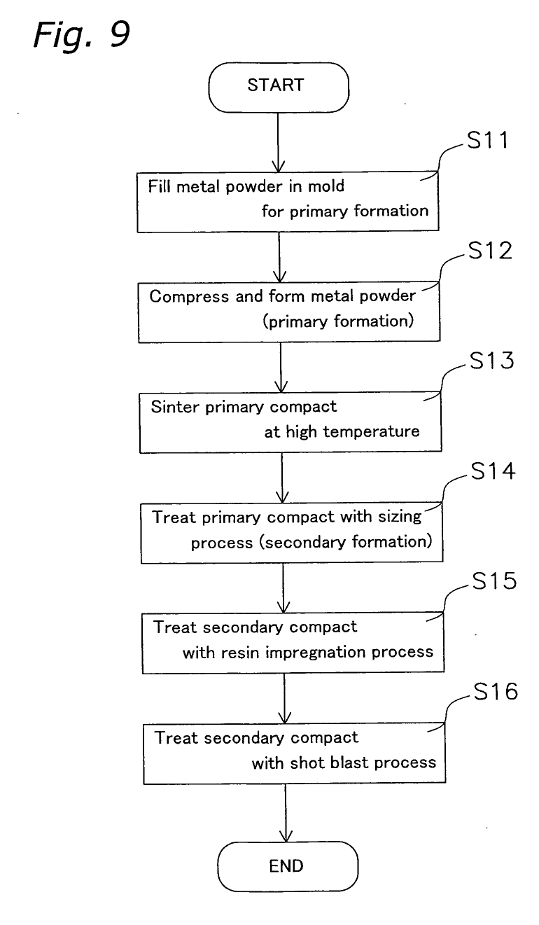

Further, as Modification 2 of Embodiment 1, a manufacturing method with an order of performing steps being changed from that of Embodiment 1 may be considered. FIG. 9 shows a flow diagram of a method for manufacturing a sleeve according to Modification 2 of Embodiment 1 of the present invention. As shown in FIG. 9, the manufacturing method includes filling step S11, forming step S12, sintering step S13, sizing process step S14, resin impregnation process step S15, and shot blast process step S16. In this manufacturing method, the dimension of the primary compact is adjusted by the sizing process step S14 after the sintering step S13. The secondary compact is treated with the resin impregnation process in the resin impregnation process step S15 before performing the shot blast process. Then, after the resin impregnation process is performed, the secondary compact is treated with the shot blast process in the shot blast process step S16.

This manufacturing method also results in the surface deformation section 48b having the less pores and the pores filled with the resin. Therefore, the same or close effects as those of the above-described manufacturing method of Embodiment 1 can be achieved. Further, since the shot blast process is performed after the resin impregnation process, the surface roughness of the secondary formation after the resin impregnation process can be improved. In short, this manufacturing method can provide the same or close effects as those of steps S1 through S7 of the above-described manufacturing method with fewer steps. The bearing stiffness can be prevented from lowering, and the manufacturing cost can be further reduced.

### ALTERNATE EMBODIMENTS

Alternate embodiments will now be explained. In view of the similarity between the first and alternate embodiments, the parts of the alternate embodiment that are identical to the parts of the first embodiment will be given the same reference numerals as the parts of the first embodiment. Moreover, the descriptions of the parts of the alternate embodiment that are identical to the parts of the first embodiment may be omitted for the sake of brevity.

Second Embodiment

In Embodiment 1, the sleeve with a high pore-sealing effect is formed by together using the shot blast process and the resin impregnation process. However, another pore-sealing process and manufacturing method is possible. The pore-sealing process of sleeve according to Embodiment 2 and the manufacturing method thereof will be described below. The present embodiment is applied mainly when sintered materials of iron are used.

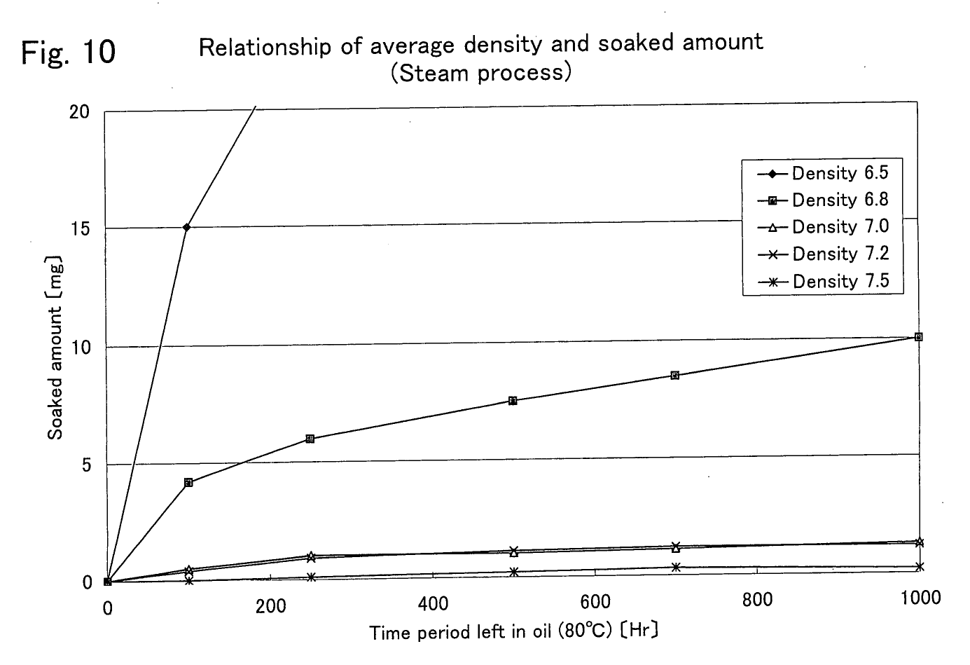

Besides the shot blast process and the resin impregnation process described above, a pore-sealing process by having the sintered metal contact steam of a high temperature and subjecting a surface to high-temperature oxidization. FIG. 10 shows a relationship between the average density and the amount of the soaked lubricating oil when the steam process is performed. FIG. 10 shows the example in which the film formed by the steam process has a thickness of 2 μm. From comparison between FIGS. 3 and 10, it is shown that the amount of the lubricating oil soaked into the sintered metal treated with the steam process is smaller than the amount when the steam process is not performed. For example, when the figures obtained at 100 hours are compared, the amount of the soaked lubricating oil becomes small when the average density is 6.8 g/cm³ or higher. It is shown that the steam process is effective. However, with only the stem process, the amount of the soaked lubricating oil cannot be reduced to a level which allows the sintered metal sleeve to be used for the hydrodynamic bearing device. This is because the thickness of the film formed by the steam process is thin and is about 2 to 5 μm.

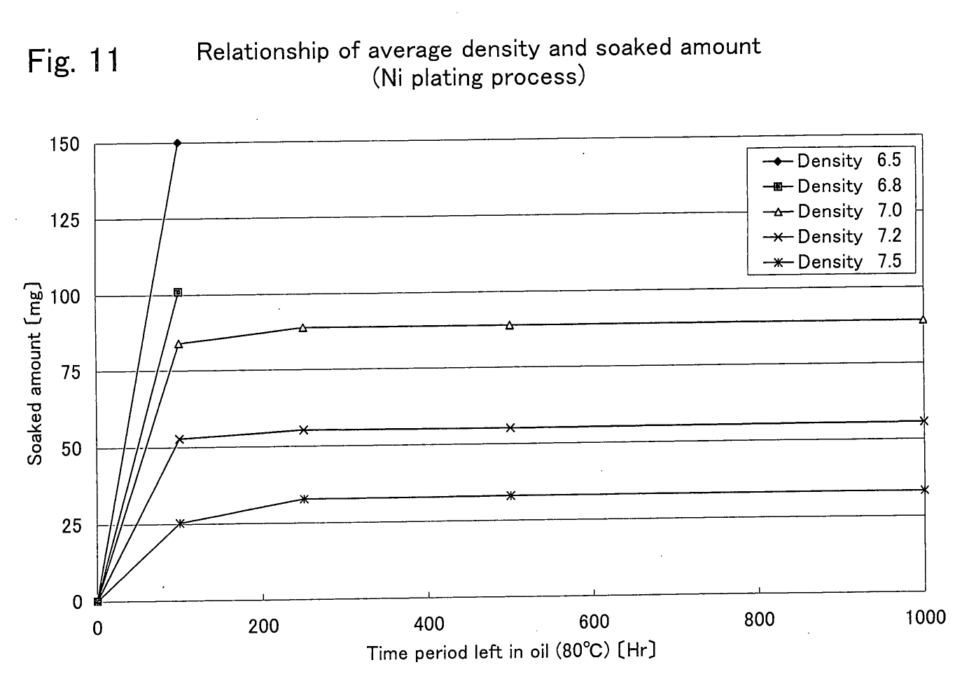

Meanwhile, in order to reduce the amount of the lubricating oil which soaks, it is possible to treat the sintered metal with a plating process to previously form a plating process layer on a surface. FIG. 11 shows a relationship between the average density and the amount of the soaked lubricating oil when the plating process is performed. The results shown in FIG. 11 are when the thickness of the plating process layer is 100 μm. As shown in FIG. 11, when the sintered metal is treated with the plating process, the amount of the soaked lubricating oil of the sintered metal treated with the plating process is smaller than that of the sintered metal which is not treated with the plating process. However, with only the plating process, the amount of the lubricating oil which soaks cannot be reduced to a level which allows the sintered metal sleeve to be used for a hydrodynamic bearing device. This is because, for performing the plating process, grease and rust have to be removed beforehand, and thus, a liquid used for removing grease and rust enters into pores of the sintered metal which prohibits the plating liquid from entering into the pores.

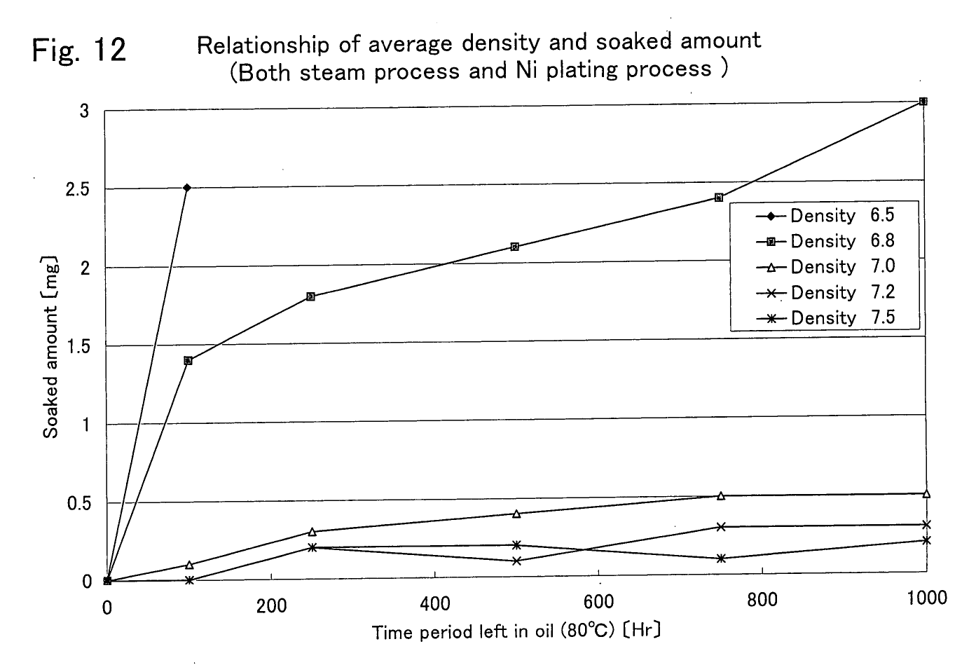

Therefore, in the manufacturing method according to the present invention, the steam process and the plating process are used together allowing the pore-sealing process which is more effective than in when the each of the processes is performed separately. FIG. 12 shows a relationship between the average density and the amount of the soaked lubricating oil when both the steam process and the plating process are performed. As shown in FIG. 12, when the sintered metal is treated with the steam process and the plating process, the amount of the soaked lubricating oil can be significantly reduced compared to that when they are performed separately (FIGS. 10 and 11). When both of the processes are used, if the density is 6.8 g/cm³ or higher (more preferably, 7.0 g/cm³ or higher), the amount of the soaked lubricating oil is reduced to 3.0 mg or lower in 1000 hours. The amount of the soaked lubricating oil can be reduced to a level which allows the sintered metal sleeve to be used for a hydrodynamic bearing device. From comparison between FIGS. 11 and 12, when the density is 6.8 g/cm³, the amount of the soaked lubricating oil of the sintered metal treated with both of the process is shown to be smaller than the amount when only the plating process is performed. In other words, by treating the sintered body with both of the steam process and the plating process, the amount of the lubricating oil which soaks can be reduced to a level which allows the sintered metal sleeve to be used for a hydrodynamic bearing device.

As described above, in order to reduce the amount of the lubricating oil which soaks, the sleeve 42 of the present invention is treated with the steam process and the plating process during a manufacturing process. Hereinafter, the sleeve 42 and details of the manufacturing method will be described.

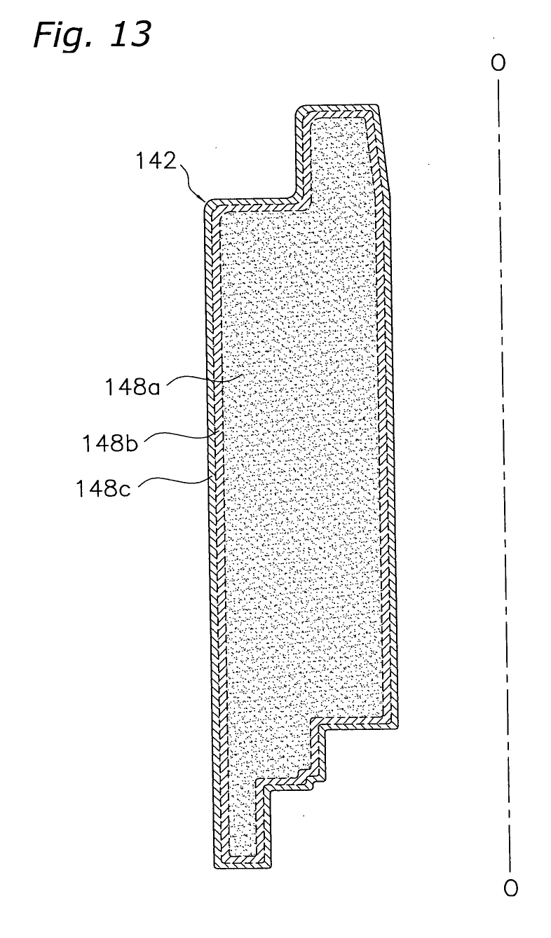

FIG. 13 is a schematic view of a vertical cross-section of the sleeve 142 according to Embodiment 2 of the present invention (left half). As shown in FIG. 13, the sleeve 142 is formed of an inner section 148a, a steam process layer 148b, and a plating process layer 148c. The inner section 148a is a tubular portion formed of metal powder for sintering and a resin for impregnation. The steam process layer 148b is a layer including iron oxide, which covers a surface of the inner section 148a. The iron oxide may be, for example, Fe₃O₄ and the like. The plating process layer 148c is a layer covering the surface of the steam process layer 148b. The plating process may be, for example, nonelectrolytic nickel plating or the like. Further, it is preferable that the thickness of the steam process layer 148b is 2 μm or larger and the thickness of the plating process layer 148c is 2 μm or larger.

In such a sleeve 142, when the iron oxide of the steam process layer 148b has electric conductivity, the plating process can be performed. As a result, the strength of the plating process layer 148c can be increased from that when only the plating process layer 148c is provided. Particularly, when the steam process layer 148b includes Fe₃O₄ having electric conductivity, one electrode is formed electrochemically. Thus, the plating process can be performed securely, and the strength of the plating process layer 148c can be increased. In this way, in the sleeve 142, the supporting pressure of the radial bearing portion 71 can be prevented from being released out through the pores, and the bearing stiffness can be prevented from lowering.

Further, in the sleeve 142, the average density of the portion of the metal powder for sintering of the inner section 148a is 6.8 g/cm³ or higher (more preferably, 7.0 g/cm³ or higher). Thus, the effect of the stem process and the plating process can be enhanced, and the strength of the plating process layer 148c can be further improved.

Moreover, in the sleeve 142, the thickness of the steam process layer 148b and the plating process layer 148c are both 2 μm or larger. Thus, the effect of the stem process and the plating process can be enhanced, and the supporting pressure of the radial bearing portion 71 can be prevented from being released out through the pores more securely.

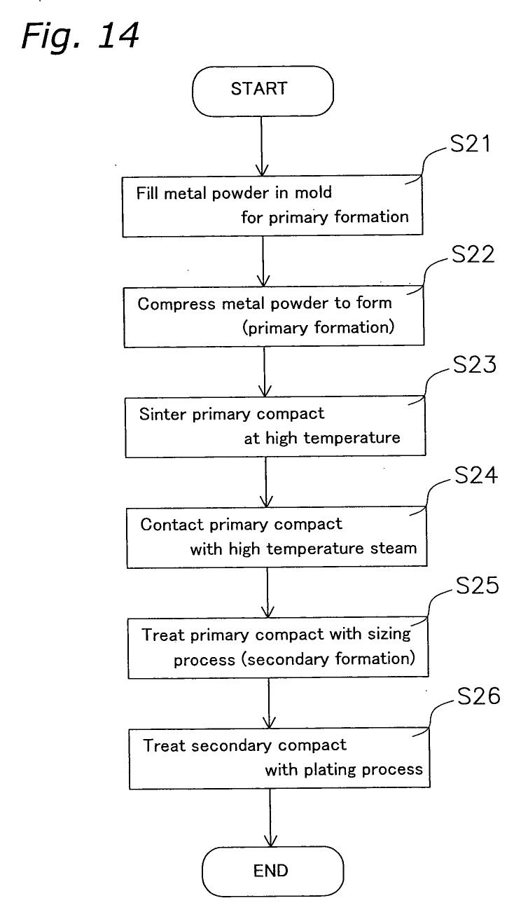

Next, a method for manufacturing the sleeve 42 will be described. FIG. 14 shows a flow diagram of a method for manufacturing a sleeve according to Embodiment 2 of the present invention. As shown in FIG. 14, the manufacturing method includes filling step S21, forming step S22, sintering step S23, steam process step S24, sizing process step S25, and plating process step S26.

In the filling step S21, metal powder including for example, iron, copper or the like is filled in a mold for primary formation. In the forming step S22, the metal powder material filled in the filling step S21 is compressed by using an upper mold and a lower mold for primary formation, and a primary compact is formed. Then, the primary compact is sintered at a high temperature in the sintering step S23.

Next, in the steam process step S24, the sintered primary compact is treated with the steam process. More specifically, the primary compact is exposed to high-temperature steam to have a surface of the primary compact high-temperature oxidized. As a result, the steam process layer 148b including iron oxide is formed on a surface of the primary compact. The iron oxide included in the steam process layer 148b may be, for example, Fe₃O₄ and the like.

In the sizing process step S25, the dimension of the primary compact is adjusted. Specifically, in the sizing process step S25, the primary compact treated with the shot steam process is set in a metal mold for secondary formation, which is formed of an inner mold and an outer mold in which the primary compact is placed at a predetermined position, and an upper mold and a lower mold which can be moved up and down freely. The primary compact is compressed by these molds. As a result, the dimension accuracy of the inner and outer peripheral surfaces and both end surfaces of the primary compact is improved, and the secondary compact is formed. By performing the sizing process, the dimension of the primary compact is adjusted, and also, the average density of the metal powder portion of the primary compact can be further increased. For example, the process can increase the average density of the portion of the metal powder of the secondary compact to 6.8 g/cm³ or higher.

After the secondary compact is formed in the sizing process step S25, the secondary body is treated with the plating process, which is surface finishing, in the plating process step S26, and the secondary compact is now the sleeve 142. The plating process may be, for example, nonelectrolytic nickel plating or the like. If the steam process layer 148b includes Fe₃O₄, the plating metal more easily enter the pores since Fe₃O₄ has electric conductivity. Thus, stronger plating layer can be formed. By performing the steam process S24 and the plating process 148c, a strong plating process layer 148c with the pores sealed with the plating metal can be formed on a surface of the sleeve 142. Therefore, the sleeve 142 which is manufactured by the above process can ensure to prevent the lubricating oil for passing inside through the pores with the steam process layer 148b and the plating process layer 148c formed on the surface. In this way, the manufacturing method can prevent the supporting pressure of the radial bearing portion 71 from being released out through the pores, and the bearing stiffness from lowering. Also, the manufacturing cost can be reduced.

The above manufacturing method can provide the sintered metal sleeve 142 which can prevent the bearing stiffness from lowering. Thus, there is no need to provide a covering member for preventing the supporting pressure from being released to the outer periphery of the sleeve 142, and the manufacturing cost can be further reduced.

In the manufacturing method, the average density of the secondary compact after the sizing process is 6.8 g/cm³ or higher, the supporting pressure of the radial bearing portion 71 can be prevented from being released out through the pores with the steam process and the plate process, and the manufacturing cost can be further reduced more securely.

Third Embodiment

In the sleeves according to Embodiments 1 and 2 as described above can prevent the supporting pressure of the bearing from being released out through the pores. However, when the shaft has a thrust flange, the shape of an end of the sleeve is complicated as shown in FIG. 2. More specifically, a joint of the sleeve main body and the tubular projection has an intricate shape. The shape of the molds for molding is also complicated. As a result, it becomes difficult to fill the metal powder in such a portion in the filling process. Thus, the density of the metal powder cannot be increased. As Embodiment 3, a manufacturing method of the sleeve will be described with reference to the manufacturing method of Embodiment 1.

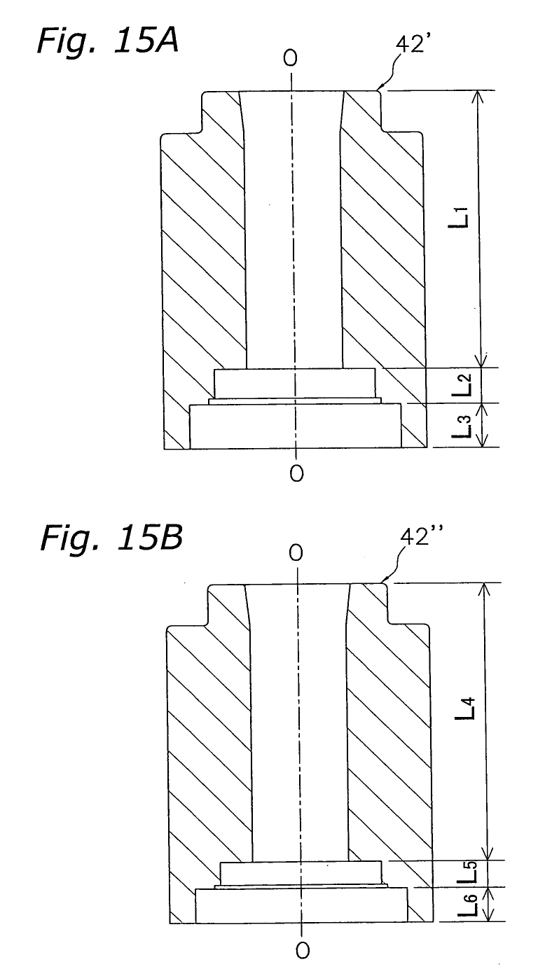

The manufacturing method has its feature in the sizing process step. FIGS. 15A and 15B show a schematic view of the sizing process of the manufacturing method according to Embodiment 3 of the present invention. FIG. 15A shows a secondary compact 42′ before the sizing process, while FIG. 15B shows a secondary compact 42″ after the sizing process. As shown in FIGS. 15A and 15B, in the sizing process step, the rate of change in a dimension of a portion corresponding to the tubular projection 42b is set to be larger than the rate of change in a dimension of a portion corresponding to a sleeve main body 42a. For example, When it is assumed that the dimension in the axial direction of the portion corresponding to the tubular projection 62b and the fixing portion 42d before the sizing process is L1, L2, and L3, and a dimension in the axial direction after the sizing process are L4, L5, and L6, the dimensions of the primary formation mold and the secondary formation mold are determined to satisfy L1/L4<L2/L5, and L1/L4<L3/L6. Instead of satisfying the L1/L4<L3/L6, the dimension may be determined.

In such a manufacturing method, the density of the metal powder at step portions such as the joint between the sleeve main body 42a and the tubular projection 42b, and the joint between the tubular projection 42b and the fixing portion 42d. As a result, by partially changing the rate of the change in the dimension at the sizing process, the density of the portion where it is difficult to fill the metal powder for sintering with the sizing process can be increase. The effect of the manufacturing method of Embodiments 1 and 2 can be further enhanced.

Fourth Embodiment

In the above Embodiments 1 and 2, a hydrodynamic bearing device which does not have a circulating function has been described. Thus, a hydrodynamic bearing device with a circulating function will be described as Embodiment 4.

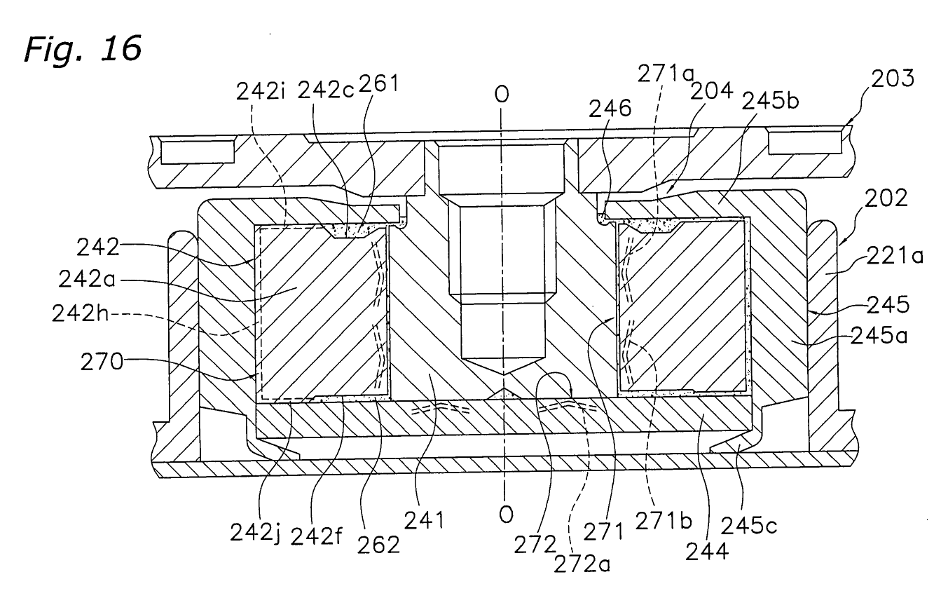

FIG. 16 is a schematic view of a hydrodynamic bearing device 204 according to Embodiment 4 of the present invention. As shown in FIG. 16, the hydrodynamic bearing device 204 supports a rotor 203 so as to be rotatable with respect to a base plate 202, and includes a sleeve 242, a shaft 241, and a thrust plate 244 and a sleeve cover 245.

The sleeve 242 is a member of a stationary part of the hydrodynamic bearing device 204. The hydrodynamic bearing device 204 is a tubular member fitted to an inner periphery of a tubular portion 221a of the base plate 202. The sleeve 242 is a sintered metal sleeve manufactured by using one of the manufacturing methods of the above embodiments. The sleeve 242 further includes a sleeve main body 242a, a plurality of first hydrodynamic grooves 271a and 271b, a first recessed portion 242c, a second recessed portion 242f, and a circulating groove 242g. The sleeve main body 242a is a tubular portion which forms a main part of the sleeve 242. The first hydrodynamic grooves 271a and 271b are grooves formed on an inner peripheral surface of the sleeve main body 242a and are located with equal intervals therebetween in a circumferential direction. The first hydrodynamic grooves 271a and 271b have, for example, a herringbone pattern. The first recessed portion 242c is a circular recessed portion formed on an upper end of the sleeve main body 242a in the axial direction. The second recessed portion 242f is a circular recessed portion formed on a lower end of the sleeve main body 242a in the axial direction. The circulating grooves 242g is a portion for circulating the lubricating oil and is a groove formed on an outer periphery and the ends of the sleeve main body 242a in the axial direction. The circulating grooves 242g will be described in more detail below. The shaft 241 is a member of a rotating part of the hydrodynamic bearing device 204, and is a pillar member located on an inner peripheral side of the sleeve 242.

The thrust plate 244 is a circular plate located on an end of the sleeve 242, and has a second hydrodynamic groove 272a. The hydrodynamic groove 272a has, for example, a spiral pattern or a herringbone pattern, and is formed at a position opposing a lower end of the shaft 241 in the axial direction.

The sleeve cover 245 is a circular member located on an outer peripheral side of the sleeve 242. Specifically, the sleeve cover 245 has a cover main body 245a, a circular plate portion 245b, and a fixing portion 245c. The cover main body 245a is a tubular portion extending along the axial direction. The sleeve 242 is fitted on an inner periphery side thereof. The circular plate portion 245b is a circular portion provided on an upper end of the cover main body 245a in the axial direction. The circular plate portion 245b extends from the cover main body 245a toward the inner periphery. The fixing portion 245c is a circular portion protruding downward in the axial direction from an end of the cover main body 245a. The fixing portion 245c sandwiches, for example, the outer periphery of the thrust plate 244 with the cover main body 245a.

The circular plate portion 245b abuts the outer periphery of the sleeve main body 242a in the axial direction. The circular plate portion 245b forms a first oil chamber 261 having a circular shape with the first recessed portion 242c. The thrust plate 244 abuts the outer peripheral portion of the sleeve main body 242a. The thrust plate 244 forms a second oil chamber 262 having a circular shape with the second recessed portion 242f. The lubricating oil 246 is filled between the shaft 241, the sleeve 242, the thrust plate 244, and the sleeve cover 245 as a working fluid.

As described above, in the hydrodynamic bearing device 204, a radial bearing portion 271 for supporting the rotor 203 in the radial direction is formed of the sleeve 242 having the first hydrodynamic grooves 271a and 271b, the shaft 241, and the lubricating oil 246 interposed therebetween. Further, a thrust bearing portion 272 for supporting the rotor 203 in the axial direction is formed of the thrust plate 244 having the second hydrodynamic groove 272a, the shaft 241, and the lubricating oil 246 interposed therebetween.

Next, the circulating groove 242g will be described in detail. The circulating groove 242g is formed of at least one (in this embodiment, a plurality of) first groove portions 242h, at least one (in this embodiment, a plurality of) second groove portions 242i, and at least one (in this embodiment, a plurality of) third groove portions 242j. The first groove portions 242h are groove portions extending in the axial direction which are formed in the sleeve main body 242a on the outer peripheral side. The second groove portions 242i are groove portions extending in the radial direction in an upper end in the axial direction. The second groove portions 242i extend from the first groove portions 242h toward the inside in the radial direction, and connect the first groove portions 242h and the first recessed portion 242c. The third groove portions 242j are groove portions extending in the radial direction which are formed in the lower end in the axial direction. The third groove portions 242j extend from the first groove portions 242h toward the inside in the radial direction, and connect the first groove portions 242h and the second recessed portions 242f.

To summarize, a circulating fluid channel 270 is formed of the circulating groove 242g between the sleeve 242, the sleeve cover 245, and the thrust plate 244. The circulating fluid channel 270 connects the first oil chamber 261 and the second oil chamber 262 as described above. The first oil chamber 261 and the second oil chamber 262 communicates with each other via a gap between the outer periphery of the shaft 241 and the inner periphery of the sleeve 242. This means that, in the hydrodynamic bearing device 204, the lubricating oil 246 between the shaft 241 and the sleeve cover 245 can circulate through the second oil chamber 262, the circulating fluid channel 270, and the first oil chamber 261.

The sleeve 242 has the circulating groove 242g instead of a circulating hole which penetrates in the axial direction. Thus, the circulating fluid channel 270 can be secured without forming the circulating hole in the sleeve 242. As a result, it is no longer necessary to form a circulating hole penetrating the sleeve in the axial direction as in conventional art. It becomes possible to manufacture a sleeve for a hydrodynamic bearing device with a circulating function by sintering. Thus, a manufacturing cost for a sleeve for a hydrodynamic bearing device with a circulating function can be reduced.

Further, since the sleeve 242 is formed by a manufacturing method according to the above described embodiments, it has a surface deformation section or a steam process layer and a plating process layer formed on its surface. Thus, a supporting pressure of the bearing can be prevented from being released out through the pores, and the bearing stiffness can be prevented from lowering. Further, it becomes also possible to prevent the lubricating oil flowing through the circulating fluid channel 270 from passing through the inside of the sleeve 242, and the circulating function can be prevented from deteriorating. The sleeve described in Japanese Laid-Open Publication No. 2003-314536 as mentioned above is formed of conventional porous sintered metal, and thus suffers from lowering of the bearing stiffness and the circulating function. However, the sleeve of the present embodiment can prevent lowering of the bearing stiffness and the circulating function. Thus, sleeves can be manufactured by sintering, and the manufacturing cost of the sleeve can be reduced securely.

Fifth Embodiment

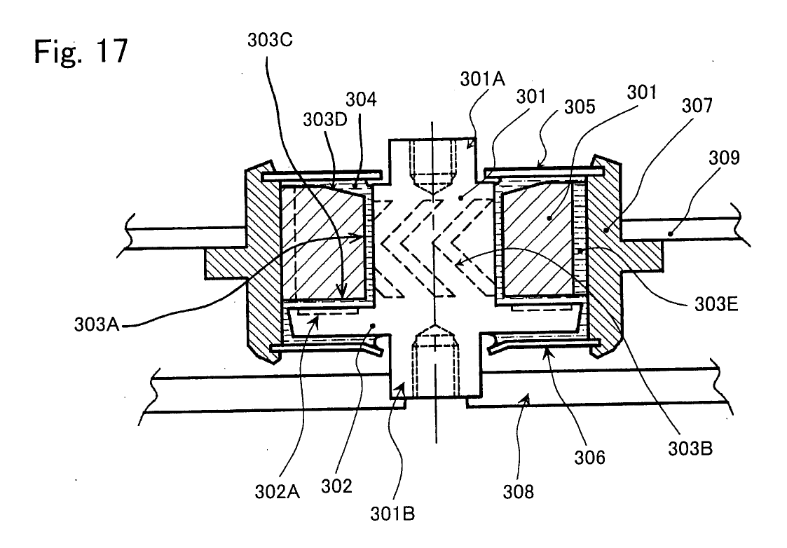

FIGS. 17 through 19 are cross sectional views showing structure of a hydrodynamic bearing device according to the present invention. The hydrodynamic bearing device is mainly formed of a shaft 301, a flange 302, a sleeve 303, lubricating oil which is a lubricating fluid (or oil) 304, an upper cover 305, a lower cover 306, a rotor 307, and a base 308. The shaft 301 is integrally formed with the flange 302. The shaft 301 is inserted into a bearing hole 303A of the sleeve 303 so as to be relatively rotatable. The flange 302 opposes a lower surface of the sleeve 303. Hydrodynamic grooves 303B are provided on at least one of an outer peripheral surface of the shaft 301 and an inner peripheral surface of the sleeve 303. Hydrodynamic grooves 302A are provided on at least one of an a lower surface of the sleeve 303, and a surface of the flange 302 which opposes the lower surface 303C of the sleeve 303. The upper cover 305 and the lower cover 306 are fixed to the sleeve 303 or the rotor 307. The bearing gaps near the hydrodynamic grooves 302A and 303B are filled with at least the oil 304. To the rotor 307, a disc 309 is fixed. To the base 308, a shaft 301 is fixed. A rotor magnet (not shown) is attached to the rotor 307. A motor stator (not shown) is fixed to the base 308 at a position opposing the rotor magnet. The rotor magnet generates an attracting force in the shaft direction, and presses the sleeve 303 toward the flange 302 with a force of a magnitude of about 10 to 50 g.

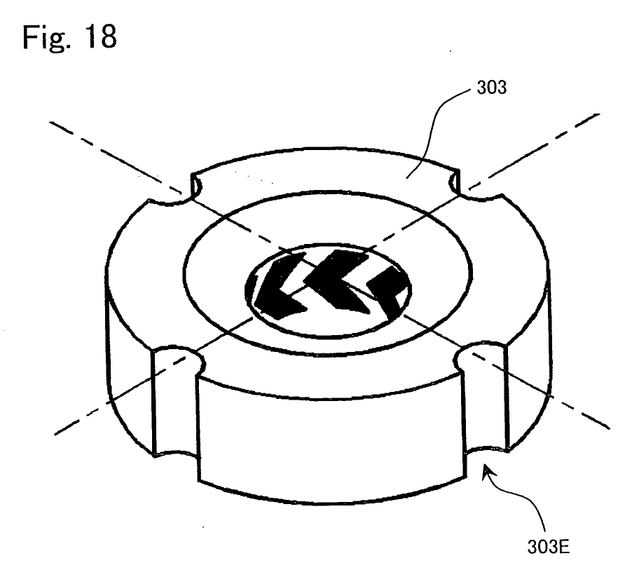

The sleeve 303 as shown in FIG. 18 is a pressed-powder molded metal sintered body containing an iron component by 80% by weight or higher. It is formed of porous material with a volume density of 85% or higher (when the material is pure iron, the specific gravity when the volume density is 100% is about 7.86). The volume density as used herein is also referred to as sintering density. The volume density equals a density of the sintered body divided by a trued density of normal component of the sintered body. The density of the sintered body equals the weight of the sintered body divided by the volume of the sintered body being sealed open pores on the surface with wax or the like based on Archimedes method. A film of magnetite (Fe₃O₄) having a thickness of 2 to 10 μm is formed on a surface of the sleeve 303. The magnetite (Fe₃O₄) film is filling the pores which have remained on a surface of the pressed-powder molded metal sintered body. The bearing hole 303A of the sleeve 303 has to be machined with a high machining precision of 1 μm or lower. Thus, a sizing process is performed at least before or after the magnetite (Fe₃O₄) film is formed. Specifically, the sleeve 303 is inserted into the mold of the bearing hole 303A, and the sizing process is performed with a press. The sizing process can be performed more readily before the magnetite (Fe₃O₄) film is formed because a load is light. When the process is performed after the magnetite (Fe₃O₄) film has been formed, the variance in the thickness of the magnetite (Fe₃O₄) film can be adjusted in the sizing process, and thus, the precision of finishing becomes better.

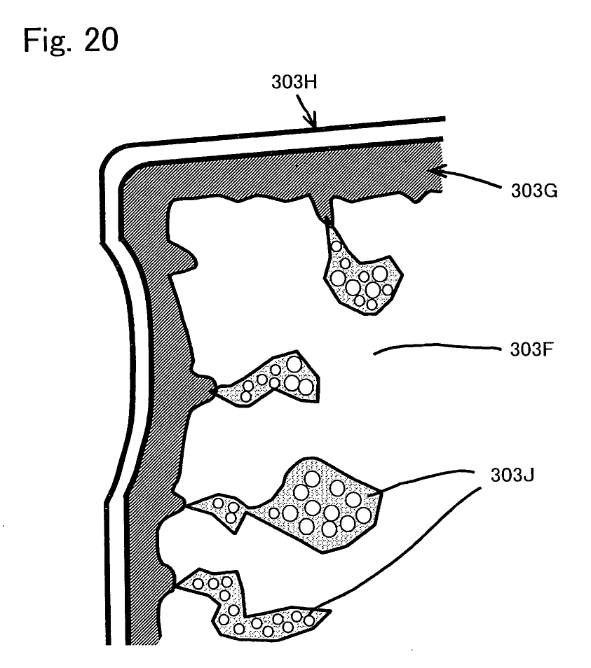

Further, as shown in FIG. 20, nonelectrolytic plating film 303H of nickel or a DLC film (for example, a three dimensional DLC coating of a plasma ion injection type for a three dimensional object, which is available from KURITA Seisakusho Co., Ltd., or the like may be used) is used as an overcoat of the magnetite (Fe₃O₄) film as necessary to improve anti-abrasion effect of the sleeve 303 and to achieve a complete surface sealing-pore effect. Further, to achieve a perfect result in sealing the pores of the sleeve 303 when there is a pinhole or a surface defect on the overcoat 303H or the magnetite (Fe₃O₄) film 303G, inner pores which are probable to remain inside the sleeve 303 as a sintered body material 303F is impregnated with a resin 303J under a low pressure as necessary.

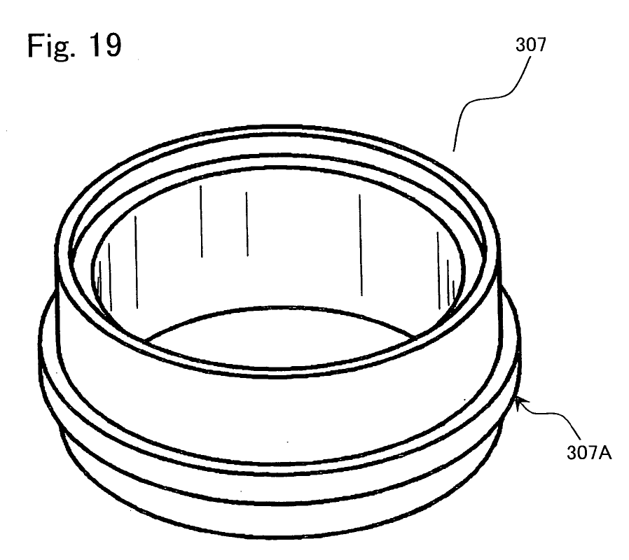

FIG. 19 shows the rotor 307. In this example, not only sleeve, but also rotor or hub sis formed of a sintered metal. The rotor is a pressed-powder molded sintered body which includes metals such as stainless metals, copper metals, hard resins, or iron or copper with a volume density of 85% or higher. When the rotor 307 is the pressed-powder molded sintered body, the magnetite (Fe₃O₄) film is formed on a surface thereof to a thickness of 2 to 10 μm. The magnetite (Fe₃O₄) film is filling the pores which have remained on a surface of the pressed-powder molded metal sintered body. The rotor 307 is integrally formed with the sleeve 303. A vertical circulating flow path 302 which allows the lubricating fluid to circulate is provided on at least one of an outer peripheral surface of the sleeve 303 and an inner periphery of the rotor 307. The rotor 307 has a step portion 307A so that the disc or the like can be readily fixed.

When the sleeve 303 and the rotor 307 are the pressed-powder molded metal sintered body including iron content by 80% by weight or more and are porous material with the density by weight of 85% or higher, the rotor 307 is press-fitted after two components are separately sintered, and then, the magnetite (Fe₃O₄) film having a thickness of 2 to 10 μm may be formed. In this way, the manufacturing cost can be low. Furthermore, the thermal coefficients of the materials of the sleeve 303 and the rotor 307 are the same. Thus, the members do not have distortion or do not deform even under a temperature change. The performance of the hydrodynamic bearing device becomes good.

Moreover, the sleeve 303 and the rotor 307 may also be processed integrally as the pressed-powder metal sintered body, and one or four pit(s) may be formed by a drilling process.

Hereinafter, an operation of a conventional fluid bearing type rotary device having a structure as described above will be described.

When a rotational force is applied to the rotor magnet (not shown), the rotor 307, the sleeve 303, the upper cover 305, the lower cover 306, and the disc 309 as shown in FIG. 17 start to rotate. As the sleeve 303 rotates, the hydrodynamic grooves 303B and 302A gather the oil 304. A pumping pressure is generated between the shaft 301 and the sleeve 303 and between the flange 302 and the sleeve 303. In this way, the shaft 301 rotates without contacting the sleeve 303 and the flange 302. Recording and reproduction of data on the disc 309 is performed by a magnetic head or an optical head (not shown). The oil can circulate because of a vertical groove 303E of the sleeve 303 as a circulation channel. Thus, necessary oil can be more easily supplied to a place where oil is insufficient, and insufficiency of oil can be prevented.

The oil 304 is held in the gap between the flange 302 and the lower cover 306 by a surface tension. When the bearing is rotating, a centrifugal force is applied to the oil 304 and the oil leakage can be prevented further. The oil 304 is also held in the gap between the upper cover 305 and an inclined surface 303D provided on an upper portion of the sleeve 303. When the bearing is rotating, a centrifugal force is applied to the oil 304 and the oil leakage can be prevented further. An inner circumference of the upper cover 305 opposes a small diameter portion 301A of the shaft 301 and the diameter is smaller than the outer diameter of the shaft 301. Thus, the centrifugal force to be applied to the oil 304 can be fully applied. The oil 304 in the gap tends to move toward an external peripheral portion where the gap is smaller because of the inclined surface by the surface tension. Thus, the oil 304 easily flows into the vertical groove 303E, and readily moves within the bearing. Therefore, when there is insufficiency in oil in the bearing, the oil 304 can move through the vertical groove and is supplied to the portion where it is required. As shown in FIG. 17, the lower end 301B of the shaft 301 is also formed to be have a diameter smaller than the outer diameter of the shaft 301. The internal diameter of the lower cover 306 is also formed to be smaller than the outer diameter of the shaft 301. Thus, the centrifugal force to be applied to the oil 304 can be fully applied and a strong oil sealing effect can be obtained.

The sleeve 303 as shown in FIG. 17 includes the magnetite (Fe₃O₄) film formed on a porous surface of the pressed-powder molded metal sintered body material. The metal powder used for pressed-powder molding can be kinds of copper such as brass. However, in order to reduce the difference in the thermal coefficients with the rotary shaft of the motor, iron powder containing iron content by 80% by weight of the total or pure iron is preferable. In this case, iron powders are pressed-powder molded, and then sintered to obtain sintered body material for the bearings.

As shown in FIG. 20, the remaining holes on the surface of the sleeve 303 are closed by the magnetite (Fe₃O₄) film. Thus, the oil 304 in the bearing gap does not enter the holes and become insufficient. Further, a problem that the oil 304 passes through the remaining hole inside the sleeve 303 and leaks out the sleeve 303 does not occur.

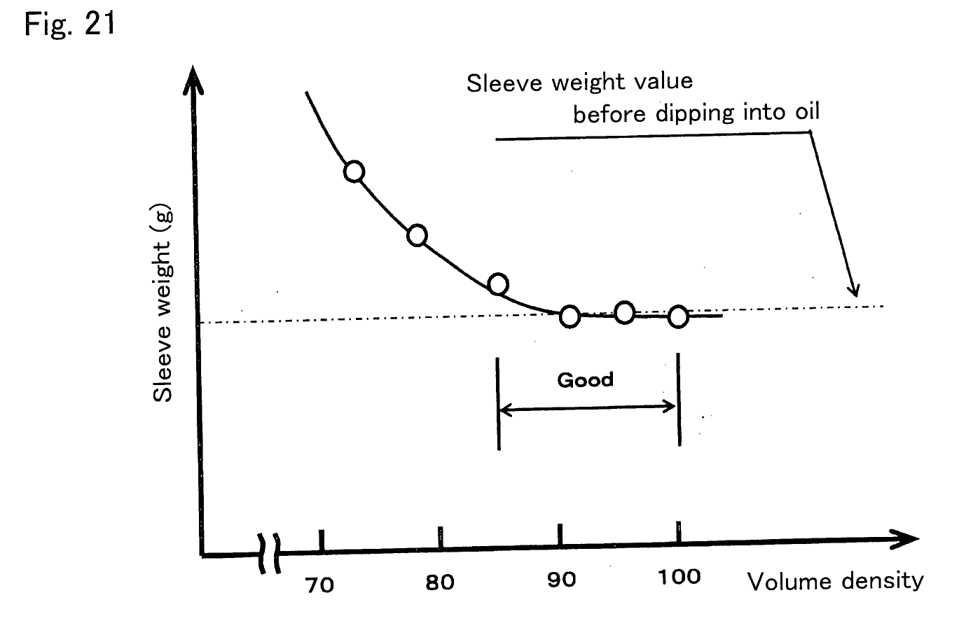

FIG. 21 shows data of the amount of oil soaked into the porous material obtained by impregnating the sleeve 303 with a sufficient amount of oil put into a beaker (not shown) by itself, leaving it at a temperature of 80° C., and then measuring an amount of change in the total weight after 1000 hours. The sleeve 303 is a porous material of the pressed-powder molded metal sintered material. The present inventors found that the pores on the surface cannot be sufficiently sealed even when the magnetite (Fe₃O₄) film is formed if the volume density is less than 85%. The weight of the soaked oil increases as indicated in FIG. 21. When the volume density is 85% or higher, the pores remaining on the surface of the sleeve 303 are sealed by providing the magnetite (Fe₃O₄) film and the sleeve 303 does not absorb the oil 315. Thus, there is no weight change after 1000 hours and the good result can be obtained.

The present inventors also found that the thickness of the magnetite (Fe₃O₄) films of the sleeve 303 which provides the good results is within the range of 2 to 10 μm. When the thickness is 2 μm or smaller, effects of sealing the porous surface are insufficient. When the thickness is 10 μm or greater, defects such that the magnetite (Fe₃O₄) film is peeled off, or broken occurs. It is found that when the thickness of the magnetite (Fe₃O₄) film is 2 to 10 μm, the surface is sealed and the oil does not soak in a combination with the condition that the volume density of the porous material is 85% or higher. With the sleeve 303 formed based on these conditions, the surface of the porous material is completely sealed and the effect of generating a pressure in the hydrodynamic bearing device can be improved.

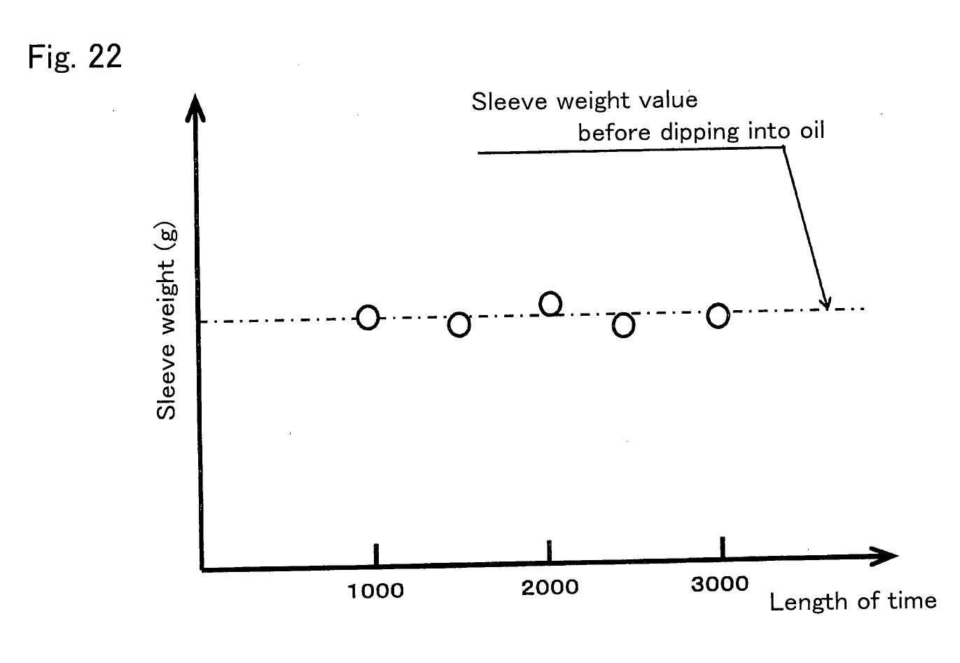

FIG. 22 shows data of the weight change measured after the sleeve 303 formed by forming the magnetite (Fe₃O₄) film on the porous surface of the pressed-powder molded metal sintered body having the volume density of 85% or higher according to the present invention is impregnated into the oil of 80° C. for 300 hours. FIG. 22 indicates that the there is no weight change in the sleeve 303 after it has been left for 3000 hours, and the oil is not absorbed inside. Since such a sleeve 303 with the surface being sealed completely is used, the hydrodynamic bearing device shown in FIG. 17 does not experience lowering of the pressure during rotation, and thus, it has high performance and high stiffness. A problem such that the oil soaks inside the sleeve 303 and the oil 304 of the bearing gap becomes insufficient to result in the bearing to seize, or the oil leaks out the sleeve 303 and the surroundings of the bearing arrangement is contaminated with gas of the oil does not occur.

In the present embodiment, the materials used for the shaft 301 and the flange 302 are a stainless steel, a high manganese chrome steel, or a carbon steel. A material finished to have a surface roughness within a range of 0.01 to 0.8 μm by machining is used for a radial bearing surface of the shaft 301.

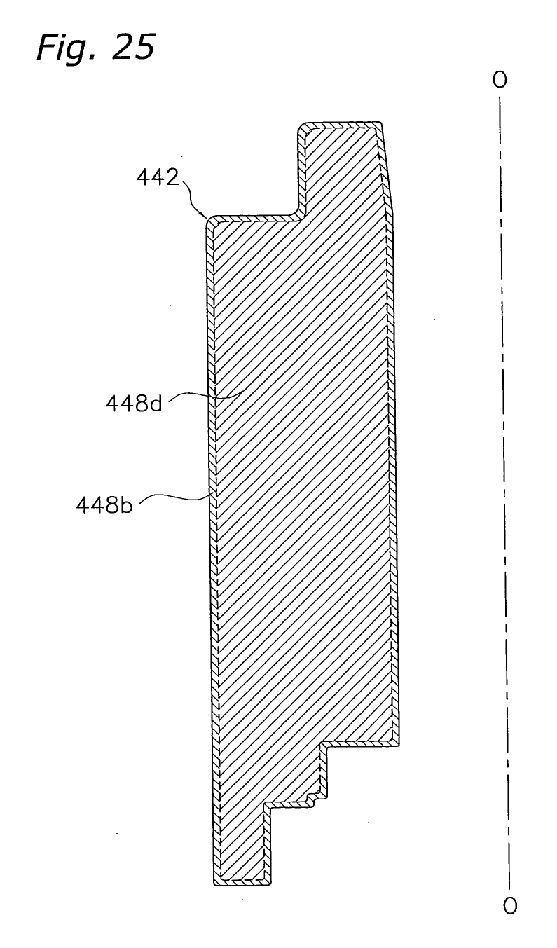

In a fluid bearing type rotary device of the present embodiment described above, both ends of the shaft 301 can be fixed and the sleeve 303 rotates. However, as shown in FIG. 25, the present invention can be applied to a hydrodynamic bearing device which has a structure that the shaft rotates without providing an adhesion groove even when the and the sleeve is directly adhered and fixed to the base without interposing other member therebetween, since an adhesion strength to fix the sleeve to the rotor by adhesion is strong because the sleeve has more coarse surface roughness than that of the sleeve formed by metal cutting.

In a fluid bearing type rotary device of the present embodiment described above, both ends of the shaft 301 can be fixed and the sleeve 303 rotates. However, the present invention can also be applied to a hydrodynamic bearing device shown in FIG. 18 of Japanese Patent Gazette No. 3155529 (Motor including hydrodynamic bearing device and recording and reproducting apparatus including the same). More specifically, the hydrodynamic bearing device has a rotor fixed to an upper side of a shaft, and a member of a ring shape attached to a lower side of the shaft. Around the ring-shaped member, an oil sump is provided adjacent to the radial bearing surface, and a thrust bearing surface is formed with the lower surface of the rotor and the upper surface of the sleeve opposing each other.

Sixth Embodiment

Since the sleeve 303 shown in FIG. 17 is a porous sintered body material, a pressure may be lowered due to leakage of a dynamic pressure when it is used for a hydrodynamic bearing device. Thus, a hydrodynamic bearing device may have a magnetite (Fe₃O₄) film formed on at least a portion of an inner peripheral surface of the sintered metal bearing material which has been treated with a sizing process, which slides with respect to a motor shaft. More specifically, in a hydrodynamic bearing device according to Embodiment 6, a magnetite (Fe₃O₄) film is formed on a porous surface by treating the sleeve 303 formed of the pressed-powder molded metal sintered body material with a water vapor process. Further, the pressed-powder molded metal sintered body material is treated with the water vapor process at an atmospheric temperature of 400 to 700° C. to form the magnetite (Fe₃O₄) film on the porous surface.

The water vapor process is known to be a method for separating contents or fixing the deformation of wood, or stabilizing dimensions of wood, or a stabilizing method for food used in a relatively low atmospheric temperature of 230° C. at most. However, the present inventors have succeeded to apply the process to the sintered metal bearing material by changing a process temperature and a process time.

A heat treatment furnace with a pressure resistant structure is preferable for the water vapor process. A sintered metal bearing material and water are put inside and the inside is sealed by putting a cap thereon. Then, the furnace is heated to a high temperature of 400 to 700° C. The water inside is evaporated by heating. As the pressure inside the chamber rises, the heating process of the sintered metal bearing material is started. After around 25 to 80 minutes of the water vapor process, depending upon the temperature inside the furnace, a dense and stable oxidized film of magnetite (Fe₃O₄), which is a spinel phase oxide, is formed on a surface of the sintered metal bearing material. The film thickness is 2 to 10 μm in this embodiment, and there is substantially no influence on a dimension accuracy of the bearing.

When the atmospheric temperature for the water vapor process is less than 400° C., sufficient film of magnetite (Fe₃O₄) cannot be formed on the bearing material. On the other hand, even when the atmospheric temperature is more than 700° C., there is no further change in generation of magnetite (Fe₃O₄). Also, the heat treatment furnace becomes expensive. Thus, in view of the productivity and the density of the film to be generated, it is preferable to perform heating at a temperature in the range of 400 to 700° C., as described above, and more preferably, the range of 600 to 700° C.

Further, a time period required for water vapor process when the atmospheric temperature is within the range of 400 to 700° C. as described above is about 25 minutes at the atmospheric temperature of 600° C., about 40 minutes at 550° C., about 65 minutes at 450° C., and about 80 minutes at 400° C. for obtaining a film of magnetite (Fe₃O₄) having a thickness of about 5 μm. Thus, a time period for process is preferably within the range of 25 to 80 minutes.

The sintered metal bearing material treated with the above water vapor process may be treated again with the sizing process as necessary to further improve the precision. The sleeve 303 treated with the water vapor process not only has improved corrosion resistance, anti-abrasion property, and mechanical strength, but also has its surface covered by metal. Thus, the water vapor process is good as an surface preparation for plating. Particularly, surface roughness is smoothed out by filling the holes. This is suitable for a hydrodynamic bearing device.

More specifically, by treating the sleeve 303 formed of a porous material of the pressed-powder molded metal sintered body with the water vapor process at the atmospheric temperature of 400 to 700° C., the size of the pores can be reduced. Further, the water vapor process can alleviate difficulty in attachment of plating to a resin surface, and enhance effects of the following plating process. Further, depending on process conditions, the air-permeability can be substantially zero. Thus, there is no lowering in the pressure due to dynamic pressure leakage, and the stiffness and rotation accuracy of the bearing can be improved. Additionally, a plating liquid can be prevented from entering and the corrosion resistance can be improved.

The thickness of the magnetite (Fe₃O₄) film to be produced can be adjusted as desired. A standard thickness is about 5 μm. Thus, dimension can be adjusted by re-compressing using a mold.

For performing the water vapor process, process can be proceeded without colliding the bearing members against each other. Thus, there is no dent left in the products. Further, the process oil remained inside can be removed by a high-temperature process before treating. Thus, no extra cleaning process is required. The produced magnetite (Fe₃O₄) film has good durability.

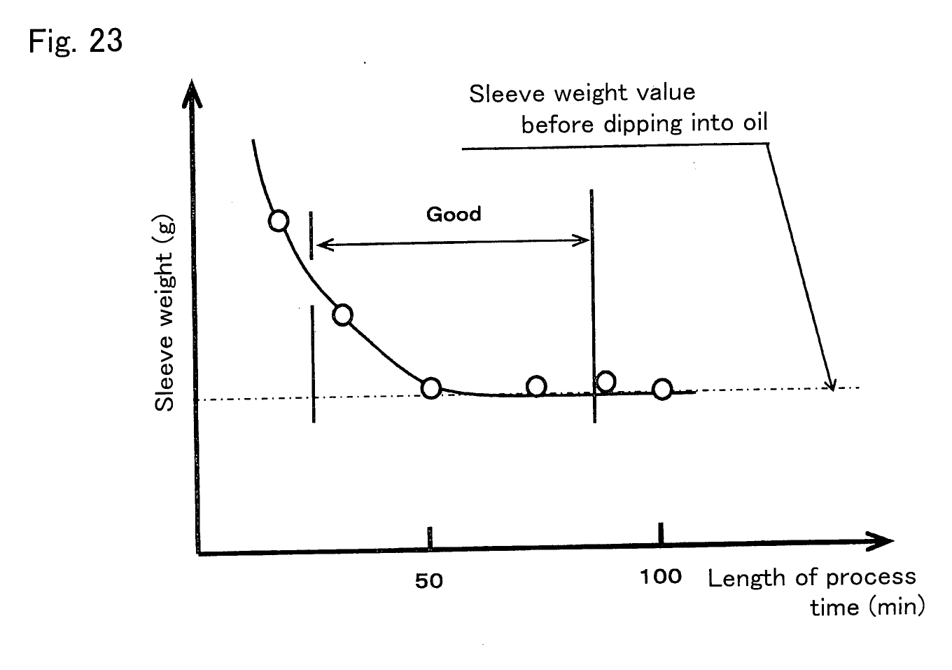

FIG. 23 shows data obtained by measuring weight change after the sleeve 303 is treated with the water vapor process for each period of time in the temperature condition of 400 to 700° C., and each of the sleeves is left in the oil of 80° C. for 500 hours. The temperature range of 400 to 700° C. is wide, and there were variances. Thus, FIG. 23 shows average values. The result of the experimentation shows that a time period of 25 to 80 minutes is good for water vapor process. When the time period is not more than 25 minutes, sealing of the surface is insufficient. On the other hand, when the time period is more than 80 minutes, the pores can be sealed, but there are problems such that the magnetite (Fe₃O₄) film can be easily removed in the following sizing process or the like, and the process is not cost-effective.

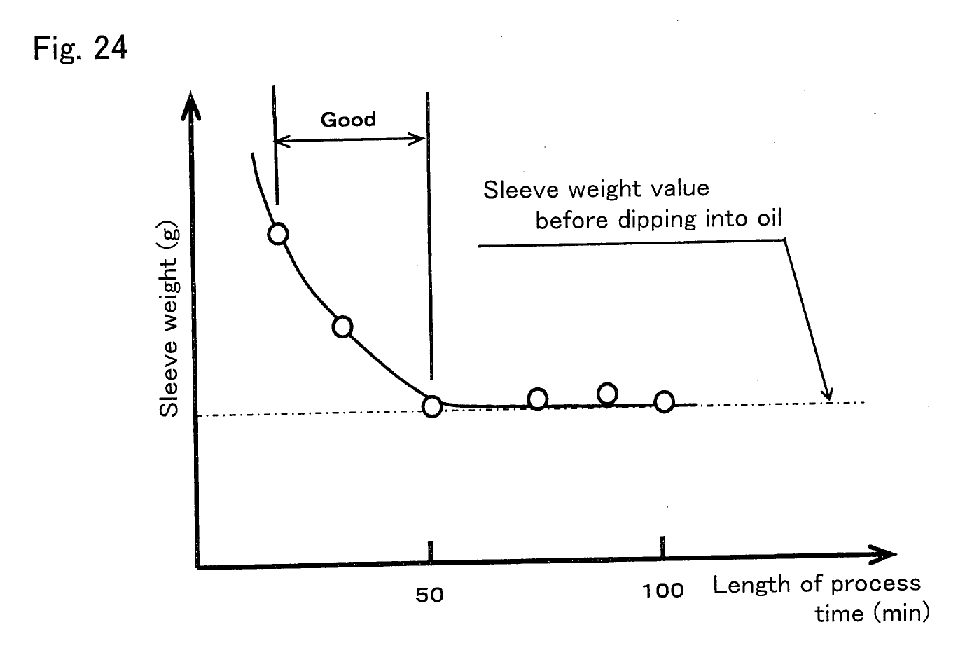

FIG. 24 shows data obtained by measuring weight change after the sleeve 303 is treated with the water vapor process for each period of time in the temperature condition of 600 to 700° C., and each of the sleeves is left in the oil of 80° C. for 500 hours. The result of the experimentation at temperature range of 600 to 700° C. shows that a time period of 15 to 50 minutes is good for water vapor process. When the time period is not more than 15 minutes, sealing of the surface is insufficient. When the time period is 50 minutes or more, sealing of the pores can be performed sufficiently. On the other hand, when the time period is more than 50 minutes, the pores can be sealed, it is not cost-effective, and problems such that the magnetite (Fe₃O₄) film can be easily removed in the following sizing process or the like occur in some cases.

Compared to performing the water vapor process at a temperature of 600° C. or below, performing the water vapor process at a temperature between 600 and 700° C. can reduce the processing time, and thus, the productivity is high. Further, since the surface temperature of the porous material rises and the activity is increased, adhesion property between the porous material layer and the magnetite (Fe₃O₄) film is high. FeO which is instable oxidized iron does not remain on the surface of the magnetite (Fe₃O₄) film, and a uniform magnetite (Fe₃O₄) film with a high purity can be produced. This is suitable for the sleeve 303 of the hydrodynamic bearing device which generates a high pressure during rotation.

Further, for further forming a nonelectrolytic plating film including nickel or DLC film on a surface of the magnetite (Fe₃O₄) film, it is found that the adhesion property is improved, and the strength against the removal of the films is increased by about 20%. Particularly, the film thickness of about 5 μm same as that of the magnetite (Fe₃O₄) film is desirable. The gap between the sleeve 303 and the shaft 301 is set to be about 5 μm. However, by performing the sizing process, an appropriate gap can be secured. By performing a plating surface, abrasion powder can be suppressed from flowing out. An iron sintered body which has a nonelectrolytic plating film including nickel or DLC film which has small difference in thermal expansion with the rotary shaft of the motor is suitable. By combining the water vapor process and the plating process, the amount of soaked lubricating fluid shown in FIG. 22 can be further improved.

The sleeve 303 is obtained by: pressing iron powder; sintering the pressed powder; performing the sizing process to obtain three types of bearing materials; putting the materials into a heat treatment furnace having pressure resistant structure (a homogenous treatment furnace of a batch type available from Tokyo Netsushori Kogyo KK.); heating to 550° C.; and maintaining for 55 minutes to perform the water vapor process. As a result, a magnetite (Fe₃O₄) film having an average thickness of 5 μm is formed on the bearing material surface. The heat furnace as used herein is not limited to the above example, and an industrial superheated water vapor process furnace (ST furnace) available from Sunray Reinetsu Co., Ltd., a combination of a bit furnace and a steam producing device and the like may be used.

The range of 400 to 700° C. of the atmospheric temperature is set as a condition of the water vapor process for the porous material of the pressed-powder molded metal sintered body in the present invention. However, by combining an superheat water vapor process allows the heating process to be performed readily under non-oxidization (inactive) condition with far-infrared ray heating, it is also possible to form a similar magnetite (Fe₃O₄) film by using an superheat water vapor process device with low energy load compared to the above atmospheric temperature range. A speed of transfer is fast in the superheat water vapor process, but it has a disadvantage that thermal efficiency is low. Thus, non-oxygen heating processing method as mentioned above adds a high thermal efficiency to the advantages of the superheat water vapor process. In this way, the quality of the bearing can be improved, and the reduction of the processing time and the cost can be achieved.

Seventh Embodiment

In the above Embodiment 2, the plating process is performed after the steam process so that the amount of soaking into the sleeve becomes equal to or lower than a predetermined amount. However, even when only the steam process is performed, the amount of soaking may not cause any practical problem in some cases. That is when there is a structure that the lubricating oil can circulate within the bearing (see FIG. 16). Such a bearing with the lubricating oil circulating structure has a lubricating oil sump (the first oil chamber 261 in FIG. 16). Even when the amount soaked into the sleeve is large, just the lubricating oil in the lubricating oils sum decreases, and the lubricating oil is always provided to the dynamic pressure grooves. Thus, problems such as seizing are less likely to occur. More specifically, as shown in FIG. 25, the sleeve 442 according to Embodiment 7 is a sleeve mainly used for a small fluid bearing device, and is formed of a steam process section 448d, and a steam process layer (oxide film layer) 448b covering the steam process section 448d. The steam process layer 448b is a layer including the oxide formed on a surface of the steam process section 448d by the steam process as in Embodiment 2 described above. The steam process section 448d is a section having the oxide formed on a surface of each particle of the metal powder for sintering with a high temperature steam entering inside the steam process layer 448b. Thus, there is oxide inside the pores between the particles of the steam process section 448d.

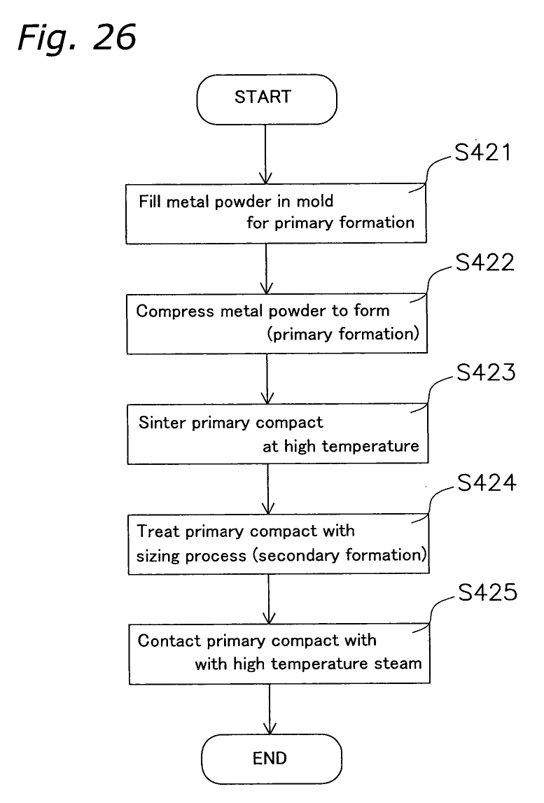

As shown in FIG. 26, a flow of the manufacturing method includes filling step S421, forming step S422, sintering step S423, sizing step S424, and steam process step S425. The differences from the flow of Embodiment 2 are that a step corresponding to the plating process step S26 for the secondary compact is omitted, and the steam process step S425 is performed after the sizing step S424.

The supporting pressure of the radial bearing portion can be prevented from being released out through the pores, and the bearing stiffness can be securely prevented from lowering. Further, since the steam process layer 448b is relatively hard layer, anti-abrasion property of the same level as in Embodiment 2 can be achieved.

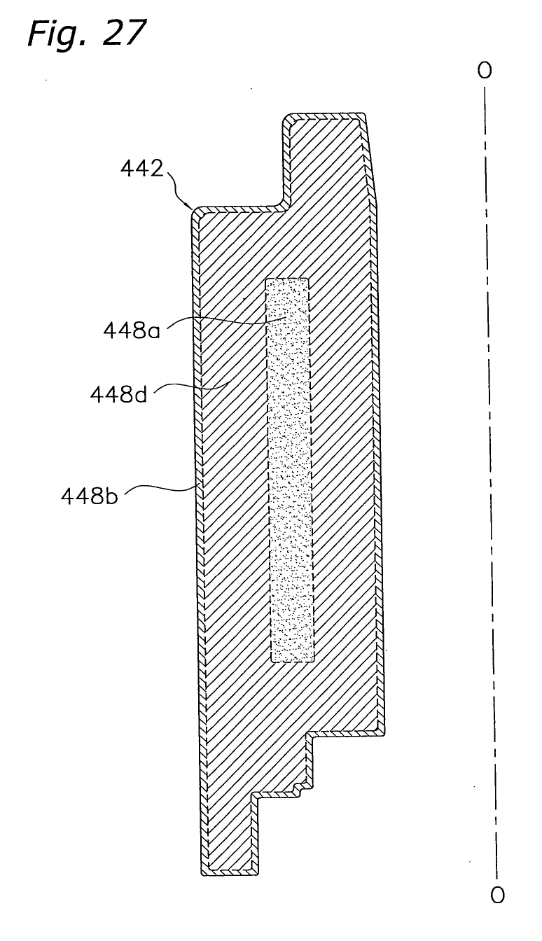

As shown in FIG. 27, an inner section 448a (a section which cannot be treated by the steam process) formed of sintered metal, which corresponds to the inner section 148a described in Embodiment 2, sometimes remains inside the steam process section 448d depending upon the size and the shape of the sleeve 442. Even in such cases, effects similar as those of the sleeve 442 shown in FIG. 25 can be achieved.

Eighth Embodiment

In Embodiment 7 described above, the sleeve 442 is covered by the steam process layer 448b, and pore sealing effect and anti-abrasion property of the level same as that when plating process is performed can be obtained. However, the steam process layer 448b is hard, but vulnerable to shock. If a crack opens due to shock, it may peel off while the bearing is being used. When the steam process layer 448b peels off, a peeled piece undesirably accelerates abrasion of the shaft. Thus, an embodiment in which at least a part of the steam process layer 448b is removed after the steam process step S425 is possible.

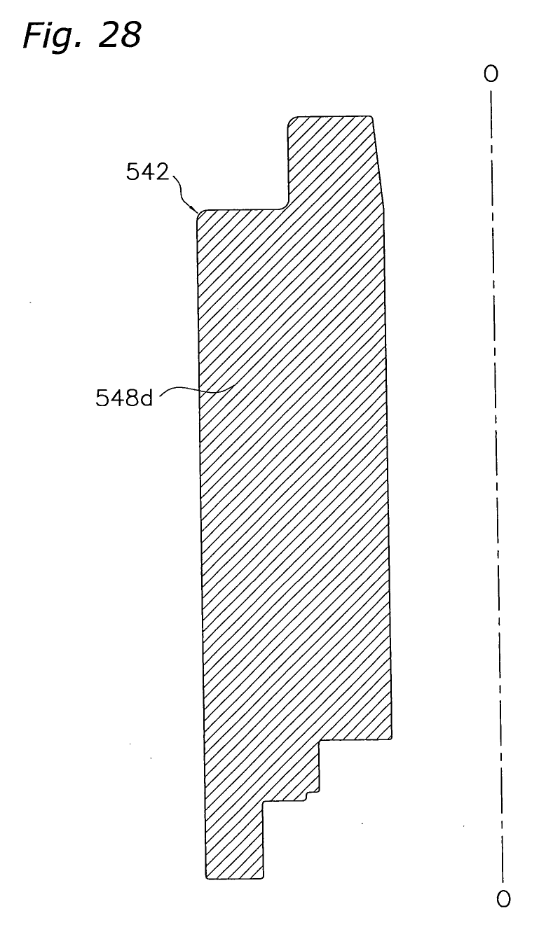

Specifically, as shown in FIG. 28, a sleeve 542 according to Embodiment 8 is similar to the sleeve 442 of Embodiment 7, but a steam process layer (oxide film layer) 448b on an inner peripheral side is removed and is formed of only a steam process section 548d.

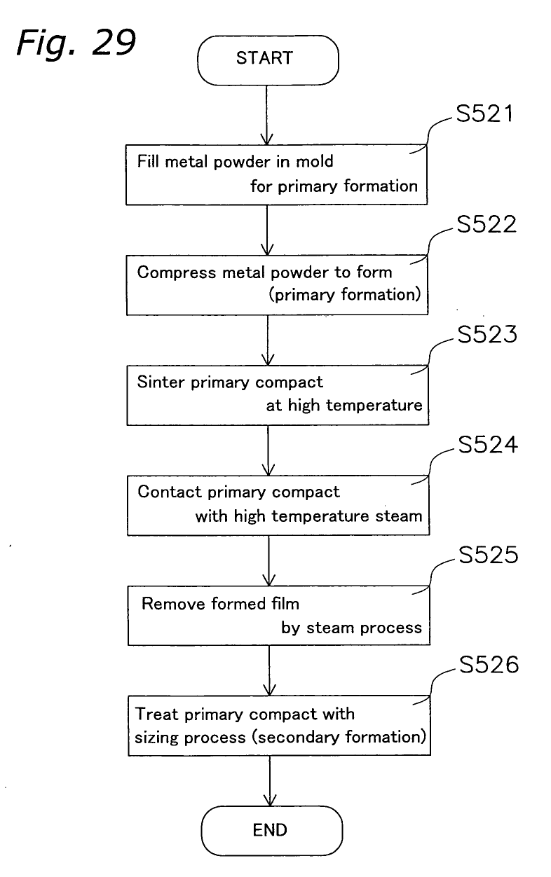

As shown in FIG. 29, a method of manufacturing includes filling step S521, forming step S522, sintering step S523, steam process step S524, film removing step S525, and sizing step S526. The difference from the flow of Embodiment 7 is that film removing step S525 is added after the steam process step S524. A method for removing the steam process layer may be, for example, shot blasting, barreling, cutting or the like. For removing the steam process layer (oxide film layer) on the entire surface as shown in FIG. 28, shot blasting is preferable. For removing only portions corresponding to radial bearing or thrust bearing, cutting such as reaming, lathing, or the like is used.

Even in this embodiment, the soaked amount may not cause a problem in a practical use sometimes depending upon the steam process layer 548b. Since the steam process layer does not peel off, the acceleration of abrasion of the shaft caused by a peeled off piece can be prevented. If the bearing has a structure which does not cause a problem in a practical use even when the soaked amount increases, cause of defects due to peeling off is removed, and there is a significant effect that the reliability improves.

The steam process section 548d has lower anti-abrasion property compared to the steam process layer 448b. However, since there is oxide, the anti-abrasion property of a level which does not cause a problem as a bearing can be secured. Moreover, the sizing step S526 after the film removing step S525 is provided for improving dimension accuracy, and surface accuracy. Thus, the step can be omitted in terms of the pore-sealing effect. Further, an inner section (a section which cannot be treated by the steam process) formed of sintered metal may remain inside the steam process section 548d as in Embodiment 7.

Ninth Embodiment

In Embodiment 2 described above, the plating process performed from above the steam process layer 148b. However, the steam process layer 148b may be removed first as described in Embodiment 8, and then the plating process may be performed as described in Embodiment 2.

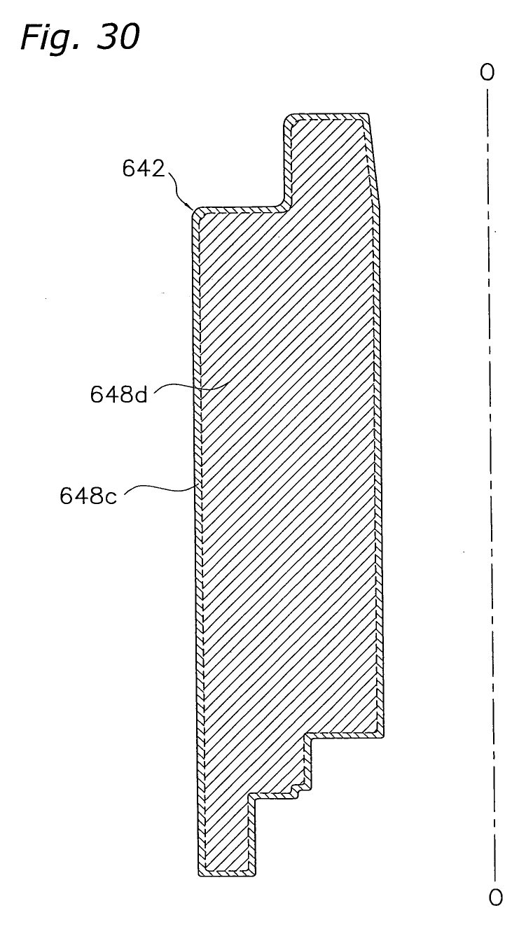

Specifically, as shown in FIG. 30, a sleeve 642 is formed of a steam process section 648d, and a plating process layer 648c which covers the steam process section 648d. Similarly to Embodiment 8, in the steam process section 648d, steam enters inside and the oxide enter the pores between particles of the sintered metal. Similarly to Embodiment 2, a plating process layer 648c is a layer formed by nonelectrolytic nickel plating process, and covers the steam process section 648d. In this way, the anti-abrasion property-and the pore sealing effect can be improved in Embodiment 8.

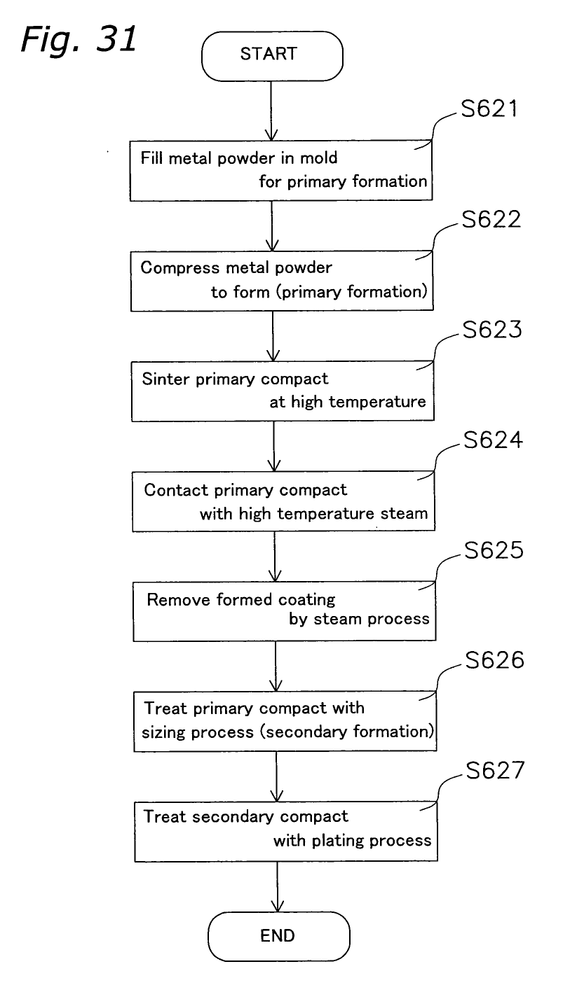

As shown in FIG. 31, a method of manufacturing includes filling step S621, forming step S622, sintering step S623, steam process step S624, film removing step S625, sizing step S626, and plating process step S627. The difference from the flow of Embodiment 8 is that the plating process step S627 is added after the sizing step S626.

This embodiment can provide a pore sealing effect similar to that of Embodiment 2. In addition, since the steam process layer is removed, even a variance in the plating process due to steam processing layer can be suppressed.

Other Embodiments

In First through Third Embodiments as described above, the thrust flange is provided on the end of the shaft. However, the present invention can also be applied to the hydrodynamic bearing device which does not include a thrust flange.

In the above-described embodiments, the working fluid is lubricating oil. However, it may be highly fluidic grease, ionic liquids and the like.

### GENERAL INTERPRETATION OF TERMS

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Terms that are expressed as “means-plus function” in the claims should include any structure that can be utilized to carry out the function of that part of the present invention. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A sleeve for a hydrodynamic bearing device, comprising:
an inner section formed of metal powder for sintering and a resin for impregnation; and
a surface deformation section which covers a surface of the inner section and is formed of metal powder for sintering,
wherein an average density of a portion of the metal powder for sintering of the surface deformation section is larger than an average density of a portion of the metal powder for sintering of the inner section.

2. A sleeve for a hydrodynamic bearing device, comprising:
an inner section formed of metal powder for sintering and a resin for impregnation; and
a surface deformation section which covers a surface of the inner section and is formed of metal powder for sintering,
wherein a density of the portion of the metal powder for sintering of the surface deformation section becomes gradually larger from a side of the inner section toward a surface.

3. A sleeve for a hydrodynamic bearing device, comprising:
an inner section formed of metal powder for sintering and a resin for impregnation; and
a surface deformation section which covers a surface of the inner section and is formed by a shot blast process.

4. A sleeve for a hydrodynamic bearing device according to claim 1, wherein an average density of the portion of the metal powder for sintering of the inner section is 6.5 g/cm³ or higher.

5. A sleeve for a hydrodynamic bearing device, comprising:
an inner section including metal powder for sintering; and
a steam process layer which covers a surface of the inner section and includes iron oxide.

6. A sleeve for a hydrodynamic bearing device according to claim 5, wherein a thickness of the steam process layer is 2 μm or greater.

7. A sleeve for a hydrodynamic bearing device according to claim 5, wherein an average density of the portion of the metal powder for sintering of the inner section is 6.8 g/cm³ or higher.

8. A sleeve for a hydrodynamic bearing device according to claim 5, wherein the iron oxide includes Fe₃O₄.

9. A sleeve for a hydrodynamic bearing device according to claim 5, further comprising a plating process layer which covers a surface of the steam process layer.

10. A sleeve for a hydrodynamic bearing device according to claim 9, wherein:
a thickness of the steam process layer is 2 μm or larger; and
a thickness of the plating process layer is 2 μm or larger.

11. A sleeve for a hydrodynamic bearing device, comprising:
metal powder for sintering; and
a steam process section with iron oxide being formed between particles of the metal powder for sintering.

12. A sleeve for a hydrodynamic bearing device into which a shaft of a hydrodynamic bearing device is inserted, comprising:
an inner section including metal powder for sintering; and
a steam process layer including iron oxide which is formed to cover a surface of the inner section,
wherein the steam process layer is removed at least from an area which generates a dynamic pressure.

13. A sleeve for a hydrodynamic bearing device into which a shaft of a hydrodynamic bearing device is inserted, comprising:
metal powder for sintering;
a steam process section with iron oxide being formed between particles of the metal powder for sintering; and
a steam process layer including iron oxide which is formed to cover a surface of the steam process section,
wherein the steam process layer is removed at least from an area which generates a dynamic pressure.

14. A hydrodynamic bearing device for supporting a rotating member so as to be rotatable with respect to a stationary member, comprising:
a sleeve according to claim 5 which is fixed to one of the stationary member and the rotating member;
a shaft which is fixed to the other of the stationary member and the rotating member and is provided on an inner peripheral side of the sleeve so as to be relatively rotatable; and
a radial bearing portion including a working fluid filled between the sleeve and the shaft, and at least one hydrodynamic groove formed on either an inner peripheral surface of the sleeve or an outer peripheral surface of the shaft.

15. A hydrodynamic bearing device for supporting a rotating member so as to be rotatable with respect to a stationary member, comprising:
a sleeve according to claim 11 which is fixed to one of the stationary member and the rotating member;
a shaft which is fixed to the other of the stationary member and the rotating member and is provided on an inner peripheral side of the sleeve so as to be relatively rotatable; and
a radial bearing portion including a working fluid filled between the sleeve and the shaft, and at least one first hydrodynamic groove formed on either an inner peripheral surface of the sleeve or an outer peripheral surface of the shaft.

16. A hydrodynamic bearing device for supporting a rotating member so as to be rotatable with respect to a stationary member, comprising:
a sleeve according to claim 12 which is fixed to one of the stationary member and the rotating member;
a shaft which is fixed to the other of the stationary member and the rotating member and is provided on an inner peripheral side of the sleeve so as to be relatively rotatable; and
a radial bearing portion including a working fluid filled between the sleeve and the shaft, and at least one first hydrodynamic groove formed on either an inner peripheral surface of the sleeve or an outer peripheral surface of the shaft.

17. A hydrodynamic bearing device for supporting a rotating member so as to be rotatable with respect to a stationary member, comprising:
a sleeve according to claim 13 which is fixed to one of the stationary member and the rotating member;
a shaft which is fixed to the other of the stationary member and the rotating member and is provided on an inner peripheral side of the sleeve so as to be relatively rotatable; and
a radial bearing portion including a working fluid filled between the sleeve and the shaft, and at least one first hydrodynamic groove formed on either an inner peripheral surface of the sleeve or an outer peripheral surface of the shaft.

18. A hydrodynamic bearing device for supporting a rotating member so as to be rotatable with respect to a stationary member, comprising:
a sleeve according to claim 5 which is fixed to the stationary member;
a shaft which is fixed to the rotating member and is provided on an inner peripheral side of the sleeve so as to be relatively rotatable;
a radial bearing portion including a working fluid filled between the sleeve and the shaft, and at least one first hydrodynamic groove formed on either an inner peripheral surface of the sleeve or an outer peripheral surface of the shaft; and
a cover member of a tubular shape fitted to an outer periphery of the sleeve.

19. A hydrodynamic bearing device for supporting a rotating member so as to be rotatable with respect to a stationary member, comprising:
a sleeve according to claim 11 which is fixed to the stationary member;
a shaft which is fixed to the rotating member and is provided on an inner peripheral side of the sleeve so as to be relatively rotatable;
a radial bearing portion including a working fluid filled between the sleeve and the shaft, and at least one first hydrodynamic groove formed on either an inner peripheral surface of the sleeve or an outer peripheral surface of the shaft; and
a cover member of a tubular shape fitted to an outer periphery of the sleeve.

20. A hydrodynamic bearing device for supporting a rotating member so as to be rotatable with respect to a stationary member, comprising:
a sleeve according to claim 12 which is fixed to the stationary member;
a shaft which is fixed to the rotating member and is provided on an inner peripheral side of the sleeve so as to be relatively rotatable;
a radial bearing portion including a working fluid filled between the sleeve and the shaft, and at least one first hydrodynamic groove formed on either an inner peripheral surface of the sleeve or an outer peripheral surface of the shaft; and
a cover member of a tubular shape fitted to an outer periphery of the sleeve.

21. A hydrodynamic bearing device for supporting a rotating member so as to be rotatable with respect to a stationary member, comprising:
a sleeve according to claim 13 which is fixed to the stationary member;
a shaft which is fixed to the rotating member and is provided on an inner peripheral side of the sleeve so as to be relatively rotatable;
a radial bearing portion including a working fluid filled between the sleeve and the shaft, and at least one first hydrodynamic groove formed on either an inner peripheral surface of the sleeve or an outer peripheral surface of the shaft; and
a cover member of a tubular shape fitted to an outer periphery of the sleeve.

22. A manufacturing method of a sleeve for a hydrodynamic bearing device, comprising:
forming a primary compact from metal powder for sintering;
sintering the primary compact;
sizing the sintered primary compact to form a secondary compact;
impregnating the secondary compact with resin; and
shot-blasting the secondary compact.

23. A manufacturing method of a sleeve for a hydrodynamic bearing device according to claim 22, wherein an average density of the portion of the metal powder for sintering of the secondary compact is 6.5 g/cm³ or higher.

24. A manufacturing method of a sleeve for a hydrodynamic bearing device, comprising:
forming a primary compact from metal powder for sintering;
sintering the primary compact;
sizing the sintered primary compact to form a secondary compact; and
contacting the sintered primary compact or the secondary compact with a high-temperature steam.

25. A manufacturing method of a sleeve for a hydrodynamic bearing device according to claim 24, further comprising:
finishing a surface of the primary compact or the secondary compact treated in the steam process.

26. A manufacturing method of a sleeve for a hydrodynamic bearing device according to claim 24, further comprising:
removing at least a part of an iron oxide film formed on a surface of the primary compact or the secondary compact at the steam process.

27. A manufacturing method of a sleeve for a hydrodynamic bearing device according to claim 25, wherein the primary compact or the secondary compact is treated with nonelectrolytic nickel plating process or DLC film coating process in the surface finishing.

28. A manufacturing method of a sleeve for a hydrodynamic bearing device according to claim 24, wherein an average density of a portion of the metal powder for sintering of the secondary compact is 6.8 g/cm³ or higher.

29. A manufacturing method of a sleeve for a hydrodynamic bearing device according to claim 24, wherein:
the primary compact includes a tubular sleeve main body and a tubular projection projecting from the sleeve main body in an axial direction; and
a rate of change in a dimension of the tubular projection is larger than a rate of change in a dimension of the sleeve main body in the sizing process.

30. A manufacturing method of a sleeve for a hydrodynamic bearing device according to claim 24, comprising:
a sleeve;
a shaft inserted into a bearing hole of the sleeve so as to be relatively rotatable; and
at least one radial bearing having hydrodynamic grooves formed on at least one of an outer peripheral surface of the shaft and an inner peripheral surface of the sleeve,
wherein a volume density of a portion of the metal powder for sintering of the secondary compact is 85% or higher.

31. A manufacturing method of a sleeve for a hydrodynamic bearing device according to claim 24, wherein:
the sleeve is brought into contact with a high-temperature steam at an atmospheric temperature within the range of 600 to 700° C. for 15 to 50 minutes in the steam process.

32. A manufacturing method of a sleeve for a hydrodynamic bearing device according to claim 24, wherein:
the sleeve is brought into contact with a high-temperature steam at an atmospheric temperature within the range of 400 to 700° C. for 25 to 80 minutes in the steam process.

33. A sleeve for a hydrodynamic bearing device according to claim 5, comprising:
at least one groove portion which is provided on an outer peripheral side and extends in the axial direction.

34. A sleeve for a hydrodynamic bearing device according to claim 11, comprising:
at least one groove portion which is provided on an outer peripheral side and extends in the axial direction.

35. A sleeve for a hydrodynamic bearing device according to claim 12, comprising:
at least one groove portion which is provided on an outer peripheral side and extends in the axial direction.

36. A sleeve for a hydrodynamic bearing device according to claim 13, comprising:
at least one groove portion which is provided on an outer peripheral side and extends in the axial direction.

37. A spindle motor, comprising:
a base plate as the stationary member;
a stator of a circular shape which is fixed to the base plate and to which a stator coil is wound around;
a hydrodynamic bearing device according to claim 14 for supporting the rotor so as to be rotatable with respect to the base plate.

38. A spindle motor, comprising:
a base plate as the stationary member;
a stator of a circular shape which is fixed to the base plate and to which a stator coil is wound around;
a hydrodynamic bearing device according to claim 15 for supporting the rotor so as to be rotatable with respect to the base plate.

39. A spindle motor, comprising:
a base plate as the stationary member;
a stator of a circular shape which is fixed to the base plate and to which a stator coil is wound around;
a hydrodynamic bearing device according to claim 16 for supporting the rotor so as to be rotatable with respect to the base plate.

40. A spindle motor, comprising:
a base plate as the stationary member;
a stator of a circular shape which is fixed to the base plate and to which a stator coil is wound around;
a hydrodynamic bearing device according to claim 17 for supporting the rotor so as to be rotatable with respect to the base plate.

41. A spindle motor, comprising:
a base plate as the stationary member;
a stator of a circular shape which is fixed to the base plate and to which a stator coil is wound around;
a hydrodynamic bearing device according to claim 18 for supporting the rotor so as to be rotatable with respect to the base plate.

42. A spindle motor, comprising:
a base plate as the stationary member;
a stator of a circular shape which is fixed to the base plate and to which a stator coil is wound around;
a hydrodynamic bearing device according to claim 19 for supporting the rotor so as to be rotatable with respect to the base plate.

43. A spindle motor, comprising:
a base plate as the stationary member;
a stator of a circular shape which is fixed to the base plate and to which a stator coil is wound around;
a hydrodynamic bearing device according to claim 20 for supporting the rotor so as to be rotatable with respect to the base plate.

44. A spindle motor, comprising:
a base plate as the stationary member;
a stator of a circular shape which is fixed to the base plate and to which a stator coil is wound around;
a hydrodynamic bearing device according to claim 21 for supporting the rotor so as to be rotatable with respect to the base plate.
